(19) United States
(12) Patent Application Publication
(10) Pub. No.: US 2010/0079685 A1
(43) Pub. Date: Apr. 1, 2010

(54) Spatial light modulator performing a gamma correction

(76) Inventors: Taro Endo, Tokyo (JP); Yoshihiro Maeda, Tokyo (JP); Akira Shirai, Tokyo (JP); Fusao Ishii, Pittsburgh, PA (US)

Correspondence Address: Bo-In Lin, 13445 Mandoli Drive, Los Altos Hills, CA, 94022, US

(21) Appl. No.: 12/587,626

(22) Filed: Oct. 9, 2009

Related U.S. Application Data
(63) Continuation-in-part of application No. 11/818,119, filed on Jun. 13, 2007.
Application No. 11/818,119 is a continuation-in-part of application No. 12/004,607, filed on Dec. 24, 2007, now Pat. No. 7,646,528.
Application No. 11/818,119 is a continuation-in-part of application No. 11/121,543, filed on May 4, 2005, now Pat. No. 7,268,932.
Application No. 12/004,607 is a continuation-in-part of application No. 11/121,543, filed on May 4, 2005, now Pat. No. 7,268,932.
Application No. 11/121,543 is a continuation-in-part of application No. 10/698,620, filed on Nov. 1, 2003, now abandoned.
Application No. 10/698,620 is a continuation-in-part of application No. 10/699,140, filed on Nov. 1, 2003, now Pat. No. 6,862,127.
Application No. 10/699,140 is a continuation-in-part of application No. 10/699,143, filed on Nov. 1, 2003, now Pat. No. 6,903,860.
(60) Provisional application No. 61/195,853, filed on Oct. 9, 2008.

(51) Int. Cl. H04N 9/31; G02B 26/00

(52) U.S. Cl. 348/761; 359/292; 348/E09.025

(57) ABSTRACT

An image projection system implemented with a spatial light modulator (SLM) comprises a plurality of pixel elements each includes a pixel memory wherein said SLM receives inputted bit data representing an image from an external image source to write the inputted data into said pixel memory wherein said SLM further adjusts a smallest period for displaying image represented by a least significant bit (LSB) of the inputted data.

This application is a Non-Provisional Application of Application 61/195,853 and claims the Priority Date of Oct. 9, 2008. This Application is also a Continuation-in Part (CIP) Application of a co-pending Non-provisional application Ser. No. 11/818,119 filed on Jun. 29, 2007 and 12/004,607 filed on Dec. 24, 2007. application Ser. Nos. 11/818,119 and 12/004,607 are Continuation-in Part (CIP) Applications of a U.S. patent application Ser. No. 11/121,543 filed on May 4, 2005, now issued into U.S. Pat. No. 7,268,932. The application Ser. No. 11/121,543 is a Continuation in part (CIP) Application of three previously filed Applications. These three Applications are Ser. No. 10/698,620 filed on Nov. 1, 2003; Ser. No. 10/699,140 filed on Nov. 1, 2003, now issued into U.S. Pat. No. 6,862,127; and Ser. No. 10/699,143 filed on Nov. 1, 2003 now issued into U.S. Pat. No. 6,903,860 by one of the Applicants of this patent application. The disclosures made in these patent applications are hereby incorporated by reference in this patent application.

### BACKGROUND OF THE INVENTION

1. Field of the Invention

The present invention relates generally to an image projection apparatus implemented with a mirror device functioning as spatial light modulator (SLM). The present invention relate more particularly to the SLM for controlling the gray scale of an image projection with non-linear control processing.

2. Description of the Related Art

After the dominance of CRT technology in the display industry for over 100 years, Flat Panel Display (FPD) and Projection Display have gained popularity because of their space efficiency and larger screen size. Projection displays using micro-display technology are gaining popularity among consumers because of their high picture quality and lower cost. There are two types of micro-displays used for projection displays in the market. One is micro-LCD (Liquid Crystal Display) and the other is micro-mirror technology. Because a micro-mirror device uses un-polarized light, it produces better brightness than micro-LCD, which uses polarized light. Although significant advances have been made in technologies of implementing electromechanical micro-mirror devices as spatial light modulators, there are still limitations in their high quality images display. Specifically, when display images are digitally controlled, image quality is adversely due to an insufficient number of gray scales.

Electromechanical micro-mirror devices have drawn considerable interest because of their application as spatial light modulators (SLMs). A spatial light modulator requires an array of a relatively large number of micro-mirror devices. In general, the number of required devices ranges from 60,000 to several million for each SLM.

Referring to FIG. 1A, an image display system 1 including a screen 2 is disclosed in a relevant U.S. Pat. No. 5,214,420. A light source 10 is used to generate light beams to project illumination for the display images on the display screen 2. The light 9 projected from the light source is further concentrated and directed toward lens 12 by way of mirror 11. Lenses 12, 13 and 14 form a beam columnator operative to columnate the light 9 into a column of light 8. A spatial light modulator 15 is controlled by a computer through data transmitted over data cable 18 to selectively redirect a portion of the light from path 7 toward lens 5 to display on screen 2. FIG. 1B shows a SLM 15 that has a surface 16 that includes an array of switchable reflective elements 17, 27, 37, and 47, each of these reflective elements is attached to a hinge 30. When the element 17 is in an ON position, a portion of the light from path 7 is reflected and redirected along path 6 to lens 5 where it is enlarged or spread along path 4 to impinge on the display screen 2 to form an illuminated pixel 3. When the element 17 is in an OFF position, the light is reflected away from the display screen 2 and, hence, pixel 3 is dark.

Most of the conventional image display devices, such as the devices disclosed in U.S. Pat. No. 5,214,420, are implemented with a dual-state mirror control that controls the mirrors to operate at a state of either ON or OFF. The quality of an image display is limited due to the limited number of gray scales. Specifically, in a conventional control circuit that applies a PWM (Pulse Width Modulation), the quality of the image is limited by the LSB (least significant bit) or the least pulse width as control related to the ON or OFF state. Since the mirror is controlled to operate in an either ON or OFF state, the conventional image display apparatuses have no way to provide a pulse width to control the mirror that is shorter than the control duration allowable according to the LSB. The least quantity of light, which determines the least amount of adjustable brightness for adjusting the gray scale, is the light reflected during the time duration according to the least pulse width. The limited gray scale due to the LSB limitation leads to a degradation of the quality of the display image.

Specifically, FIG. 1C exemplifies, as related disclosures, a circuit diagram for controlling a micromirror according to U.S. Pat. No. 5,285,407. The control circuit includes memory cell 32. Various transistors are referred to as “M*” where “*” designates a transistor number and each transistor is an insulated gate field effect transistor. Transistors M5, and M7 are p-channel transistors; transistors, M6, M8, and M9 are n-channel transistors. The capacitances, C1 and C2, represent the capacitive loads in the memory cell 32. The memory cell 32 includes an access switch transistor M9 and a latch 32a based on a Static Random Access switch Memory (SRAM) design. All access transistors M9 on a Row line receive a DATA signal from a different Bit-line 31a. The particular memory cell 32 is accessed for writing a bit to the cell by turning on the appropriate row select transistor M9, using the ROW signal functioning as a Word-line. Latch 32a consists of two cross-coupled inverters, M5/M6 and M7/M8, which permit two stable states that include a state 1 when is Node A high and Node B low, and a state 2 when Node A is low and Node B is high

The control circuit positions the micro-mirrors to be at either an ON or an OFF angular orientation, as that shown in FIG. 1A. The brightness, i.e., the number of gray scales of display for a digitally control image system, is determined by the length of time the micro-mirror stays at an ON position. The length of time a micromirror is in an ON position is controlled by a multiple bit word.

FIG. 1D shows the “binary time intervals” when controlling micromirrors with a four-bit word. As shown in FIG. 1D, the time durations have relative values of 1, 2, 4, 8, which in turn define the relative brightness for each of the four bits where “1” is the least significant bit and “8” is the most significant bit. According to the control mechanism as shown, the minimum controllable differences between gray scales for showing different levels of brightness is a represented by the “least significant bit” that maintains the micromirror at an ON position.

For example, assuming n bits of gray scales, one time frame is divided into 2ⁿ−1 equal time periods. For a 16.7-millisecond frame period and n-bit intensity values, the time period is 16.7/(2ⁿ−1) milliseconds.

Having established these times for each pixel of each frame, pixel intensities are quantified such that black is a 0 time period, the intensity level represented by the LSB is 1 time period, and the maximum brightness is 2ⁿ−1 time periods. Each pixel's quantified intensity determines its ON-time during a time frame. Thus, during a time frame, each pixel with a quantified value of more than 0 is ON for the number of time periods that correspond to its intensity. The viewer's eye integrates the pixel brightness so that the image appears the same as if it were generated with analog levels of light.

For controlling deflectable mirror devices, the PWM applies data to be formatted into “bit-planes”, with each bit-plane corresponding to a bit weight of the intensity of light. Thus, if the brightness of each pixel is represented by an n-bit value, each frame of data has the n-bit-planes. Then, each bit-plane has a 0 or 1 value for each mirror element. According to the PWM control scheme described in the preceding paragraphs, each bit-plane is independently loaded and the mirror elements are controlled according to bit-plane values corresponding to the value of each bit during one frame. Specifically, the bit-plane according to the LSB of each pixel is displayed for 1 time period.

Incidentally, a gamma correction circuit is known as a circuit which is used for a display apparatus and which converts input/output characteristic.

Circuits performing correction as noted in the following paragraphs (1.1) through (1.3) are known as representative gamma correction circuits.

(1.1) Broadcast Gamma Correction

This correction is primarily used for removing a gamma correction added to television broadcasting signals and the correction is also called de-gamma. Here, the gamma correction added to the television broadcasting signals means that the data characteristic of a television broadcasting signal is pre-corrected to about γ=0.4 in accord with the input/output characteristic (i.e., γ=2.2) of a cathode ray tube (CRT) that is conventionally used so that a linear display characteristic is obtained when performing displaying on the CRT. In recent years, the general practice is performed to cancel the gamma correction pre-added to the signal and generate a video signal having a linear characteristic for use in displaying in order to be compatible to a display device having a display characteristic that is different from that of the CRT.

(1.2) Display Gamma Correction

Even with the input/output characteristic of the display apparatus, the characteristic that is remarkable with the CRT as described above, a completely linear input/output characteristic cannot still be obtained for a liquid crystal display (LCD) apparatus. Therefore, gamma correction for correcting an input video signal in accord with the display characteristic of the LCD apparatus is required. A correction performed in such a case is called the display gamma correction.

(1.3) Gamma Correction on the Basis of a User Setup

In a display apparatus such as a television and a projector, the input/output characteristic of a displaying video image can be modified on the basis of a user manually performing a parameter adjustment or selecting from among a plurality of pre-set modes in order to correct the brightness characteristic of different video images attributable to the user's audio/video environment due to the brightness and color (or hue) of a room illumination and by a video picture work supplied in a digital versatile disk (DVD) or the like. In such a case, the gamma correction is carried out on the basis of the user's setup.

The gamma correction circuit applied to a video signal can be categorized into two systems described in the following paragraphs (2.1) and (2.2).

(2.1) An Input/output Characteristic Conversion through Arithmetic Operation

Known technique examples: U.S. Pat. No. 7,042,523, U.S. Pat. No. 5,087,966, and the like

This conversion method uses a plurality of arithmetic operation circuits to carry out correction so as to obtain a nonlinear output characteristic corresponding to the brightness level of an input signal. This method, using an exponential or logarithmic conversion or a polynomial expression to convert an input signal, depends highly on the process capability of a device and has a low degree of freedom in the arithmetic expression in order to carry out an accurate correction in response to the displaying speed, and therefore it is very difficult to attain a complex characteristic on the basis of a user's setup.

(2.2) An Input/output Characteristic Conversion Using a Memory Lookup Table

Known technique examples: U.S. Pat. No. 6,943,836, U.S. Pat. No. 5,303,055, U.S. Pat. No. 6,909,411, and the like

This conversion method, having a table of output words in accordance with the inputted digital data words, determines an output word one to one for each word of the digital data. It is possible to change the characteristics of an output corresponding to the input with a use of the table. On the other hand, the method is faced with a problem that the scale of the table grows with the number of pixels of video images in recent years, requiring a vast memory space particularly in the case of having the setup information of a plurality of display modes and accordingly increasing the scale of the circuit.

Meanwhile, when the word of digital data is converted, and if the conversion is carried out so as to obtain nonlinear output data for each value of the input data that is capable of containing, for example, 1024 pieces (i.e., 10 bits) of information, a part of values included in the input data will be lost. Describing the problem by taking a simple example, if a conversion is carried out so as to obtain nonlinear output data for each value of the input data that is capable of containing 8 pieces (i.e., 3 bits) of information, the values of the respective output data are 0, 0, 1, 2, 3, 4, 5 and 7 for the values of the input data 0, 1, 2, 3, 4, 5, 6 and 7, producing seven kinds of output data for eight kinds of input data, losing a part of the values (i.e., “6”) included in the input data, as shown in FIG. 2A. FIG. 2B is a diagram showing the output characteristic in this event.

Applying such a conversion to the gray scale data of brightness decreases the number of gray scale levels included in the output data as compared to the number of gray scale levels included in the input data. This in turn means that the gray scale levels included in the input data cannot be displayed correctly, and therefore the gray scale level is degraded.

Also in the case of performing a conversion in the above described (2.1) method, that is, using an arithmetic operation a similar degradation in the gray scale representation will result, so long as the number of gray scale levels in the output that is displayable by a display apparatus does not increase relatively to the number of gray scale levels included in the input data.

### SUMMARY OF THE INVENTION

In consideration of the situation as described above, the present invention aims at providing a spatial light modulator (SLM) and a control apparatus therefor, which are enabled to correct the input/output characteristic of a video image displaying without depending on a circuit scale and a process capability and to display a video image allowing no degradation in the number of gray scale level against that of the input data.

In order to accomplish the aforementioned aim, one embodiment of the present invention is an image projection system implemented with a spatial light modulator (SLM) comprises a plurality of pixel elements each includes a pixel memory wherein said SLM receives inputted bit data representing an image from an external image source to write the inputted data into said pixel memory wherein said SLM further adjusts a smallest period for displaying image represented by a least significant bit (LSB) of the inputted data.

Another embodiment of the present invention is an image projection system implemented with a spatial light modulator (SLM) comprises a plurality of pixel elements each includes a pixel memory wherein said SLM receives inputted bit data representing an image from an external image source to write the inputted bit data into said pixel memory wherein said SLM further controls and adjusts a period for retaining the inputted data in the pixel memory. Yet another embodiment of the present invention is a n image projection system comprises a control apparatus connected to a spatial light modulator (SLM) wherein the control apparatus transmitting video data for displaying a video image to said SLM; and said control apparatus further controls and adjusts a time interval for transmitting and writing said video data to said SLM.

Yet another embodiment of the present invention is an image projection system comprises a control apparatus, connected to a spatial light modulator (SLM) wherein the control apparatus includes a frame buffer for temporarily storing video data, and the control apparatus further controls and adjusts an interval of reading the video data from the frame buffer.

### BRIEF DESCRIPTION OF THE DRAWINGS

The present invention is described in detail below with reference to the following Figures.

FIG. 1A is a schematic showing a conventional two-dimensional digital video system using a deflectable micromirror device;

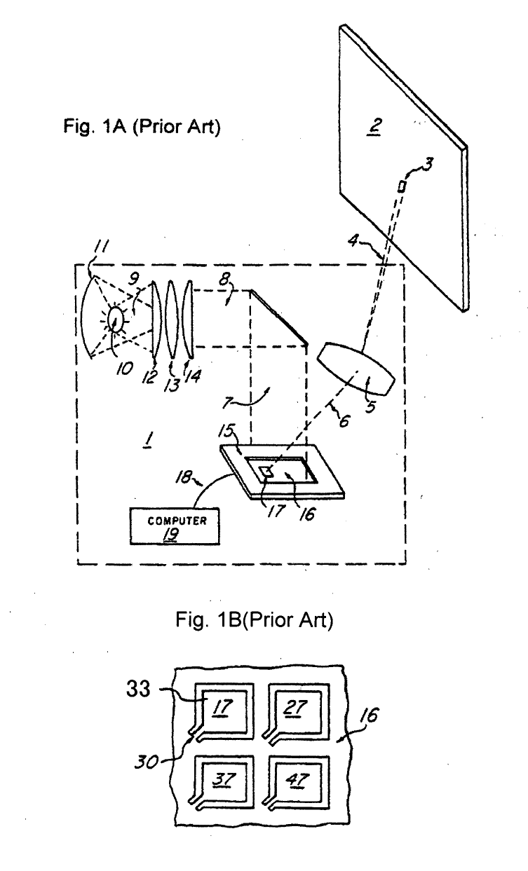

FIG. 1B is a schematic showing a part of the deformable micromirror device shown in FIG. 1A;

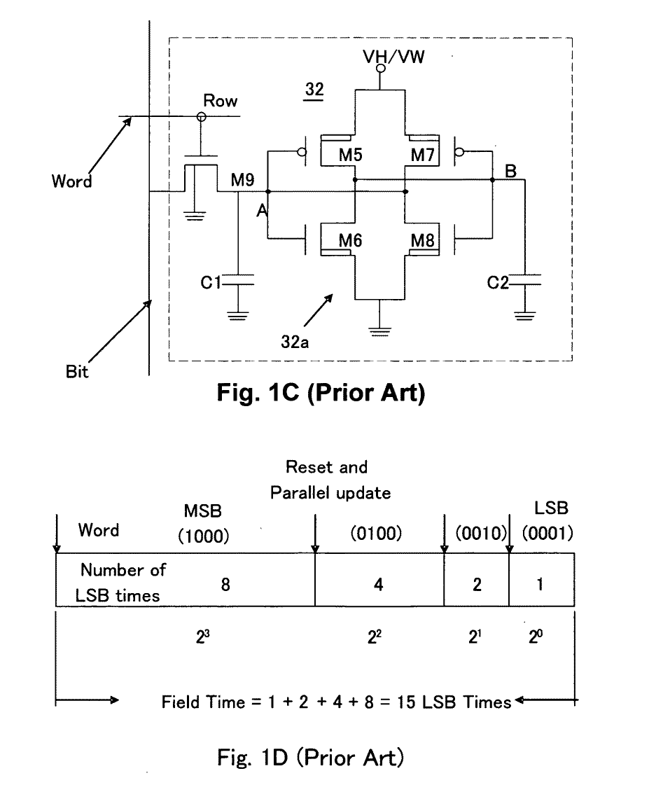

FIG. 1C is a diagram showing a conventional control circuit of a micromirror;

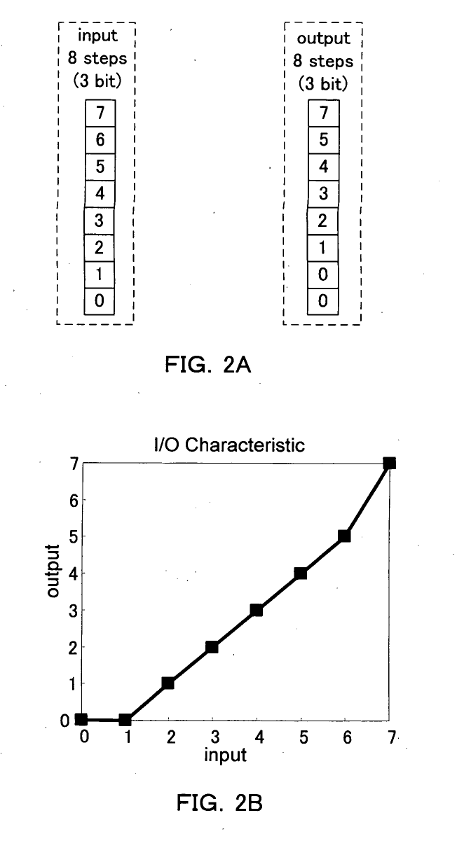

FIG. 1D is a schematic showing binary time intervals when a control is performed with 4-bit words;

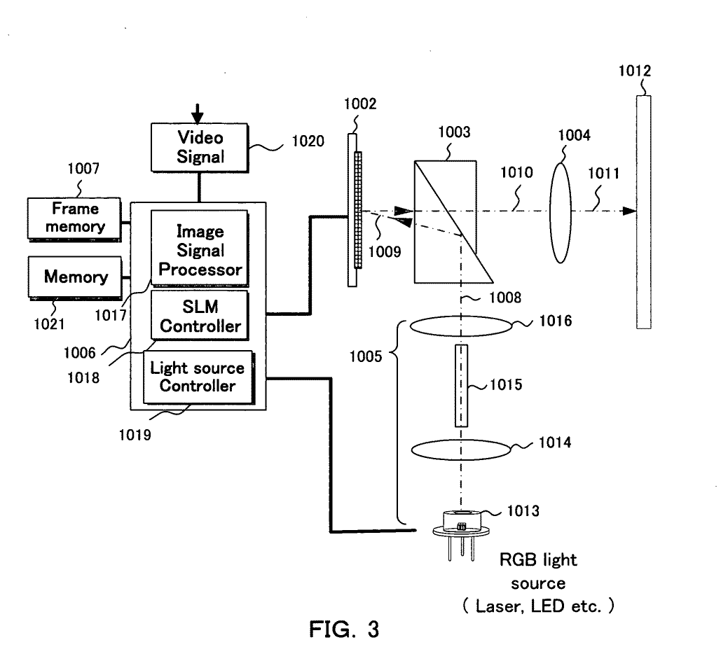

FIGS. 2A and 2B are diagrams showing an exemplary input/output conversion;

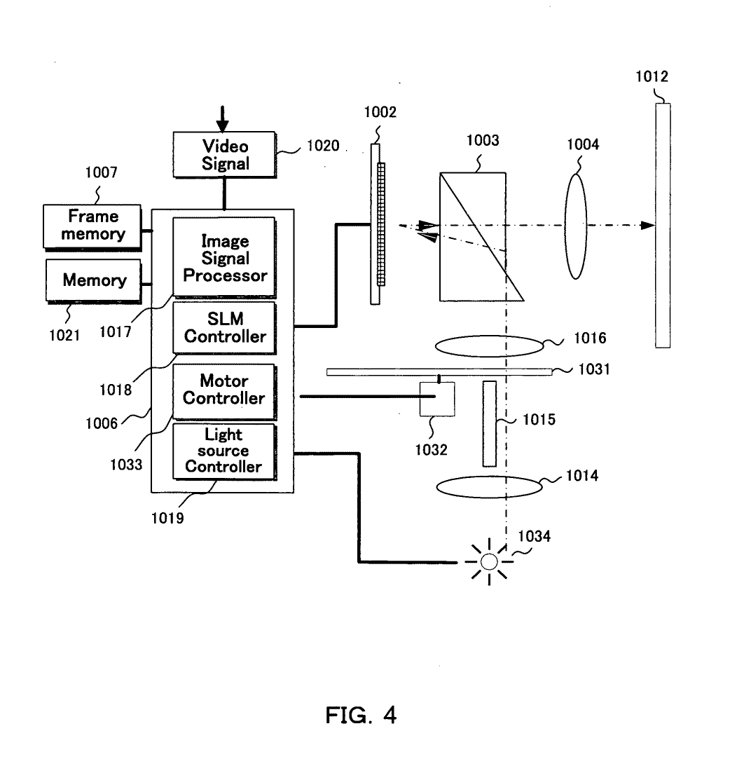

FIG. 3 is a diagram showing an exemplary comprisal of a display apparatus according to a preferred embodiment;

FIG. 4 is a diagram showing another exemplary comprisal of a display apparatus according to a preferred embodiment;

FIG. 5 is a diagram showing an exemplary comprisal of a spatial light modulator (SLM) comprised in a display apparatus according to a preferred embodiment;

FIG. 6 is a diagram showing an exemplary circuit configuration of an individual pixel unit comprised in an SLM;

FIGS. 7A and 7B are diagrams showing an exemplary ON control for a mirror of an individual pixel element;

FIGS. 8A and 8B are diagrams showing an exemplary OFF control for a mirror of an individual pixel element;

FIGS. 9A and 9B are diagrams showing an exemplary oscillation control for a mirror of an individual pixel element;

FIG. 10 is a diagram showing an exemplary control when binary data is used as the pixel control data;

FIG. 11 is a diagram showing an exemplary control when non-binary data is used as the pixel control data;

FIG. 12 is a diagram showing another exemplary control when non-binary data is used as the pixel control data;

FIG. 13A is a diagram showing an exemplary control when a pixel element is ON/OFF-controlled by using non-binary data as the pixel control data;

FIG. 13B is a diagram showing an exemplary control when a pixel element is ON/OFF-controlled by using non-binary data of which the time width of each segment is changed;

FIGS. 14A and 14B are diagrams for describing an example of performing an input/output characteristic conversion by changing the time width of each time slot of a part of non-binary data for one frame period, that is, the part to be used for an ON/OFF control;

FIGS. 15A and 15B are diagrams for describing another example of performing an input/output characteristic conversion by changing the time width of each time slot of a part of non-binary data for one frame period, that is, the part to be used for an ON/OFF control;

FIG. 16A is a diagram for describing yet another example of performing an input/output characteristic conversion by changing the time width of each time slot of a part of non-binary data for one frame period, that is, the part to be used for an ON/OFF control;

FIG. 16B is a diagram for describing yet another example of performing an input/output characteristic conversion by changing the time width of each time slot of a part of non-binary data for one frame period, that is, the part to be used for an ON/OFF control;

FIGS. 17A and 17B are diagrams for describing yet another example of performing an input/output characteristic conversion by changing the time width of each time slot of a part of non-binary data for one frame period, that is, the part to be used for an ON/OFF control;

FIG. 18 is a diagram showing an exemplary partial comprisal included in a display apparatus according to a preferred embodiment;

FIG. 19 is a diagram showing exemplary display timing in a period used for an ON/OFF control within one frame period;

FIG. 20 is a diagram showing exemplary display timing in a period used for an ON/OFF control within one frame period in an exemplary comprisal equipped with memory in place of a latch circuit;

FIG. 21 is a diagram showing an exemplary partial comprisal included in a display apparatus according to a preferred embodiment;

FIG. 22 is a diagram showing exemplary data write timing writing to a memory array in a period used for an ON/OFF control within one frame period in the exemplary comprisal shown in FIG. 21;

FIG. 23 is a diagram showing an exemplary control when configuring so as to add a modulation control time period in accordance with an adjustment value to the modulation control time of the individual pixel element of an SLM within one frame period;

FIG. 24 is a diagram showing an exemplary control when configuring so as to subtract a modulation control time in accordance with an adjustment value from the modulation control time of the individual pixel element of an SLM within one frame period;

FIG. 25A is a diagram showing an exemplary input/output characteristic obtained by configuring so as to add a modulation control time in accordance with an adjustment value;

FIG. 25B is a diagram showing an exemplary input/output characteristic obtained by configuring so as to subtract a modulation control time in accordance with an adjustment value;

FIGS. 26A, 26B, 26C and 26D are diagrams collectively showing an exemplary optical comprisal of a two-panel display apparatus;

FIG. 27 is a diagram showing another exemplary comprisal of a two-panel display apparatus;

FIG. 28 is a block diagram showing the configuration of an SLM according to another preferred embodiment of the present invention;

FIG. 29 is a diagram showing one pixel of a pixel array;

FIG. 30 is a diagram showing the configuration of an analog mirror driver;

FIG. 31 is a diagram showing an exemplary analog memory circuit;

FIG. 32 is a diagram showing an exemplary comparator circuit;

FIG. 33 is a diagram showing a waveform for describing an exemplary operation of a comparator circuit;

FIG. 34 is a diagram showing a waveform for describing another exemplary operation of a comparator circuit;

FIG. 35 is a diagram showing a waveform for describing a timing generation;

FIG. 36 shows diagram and table listing the sizes and area sizes of transistors in accordance with standing voltages; and

FIG. 37 is a block diagram when using an SLM according to another preferred embodiment of the present invention.

### DESCRIPTION OF THE PREFERRED EMBODIMENTS

Preferred embodiments according to the present invention are described in the following with reference to the accompanying drawings.

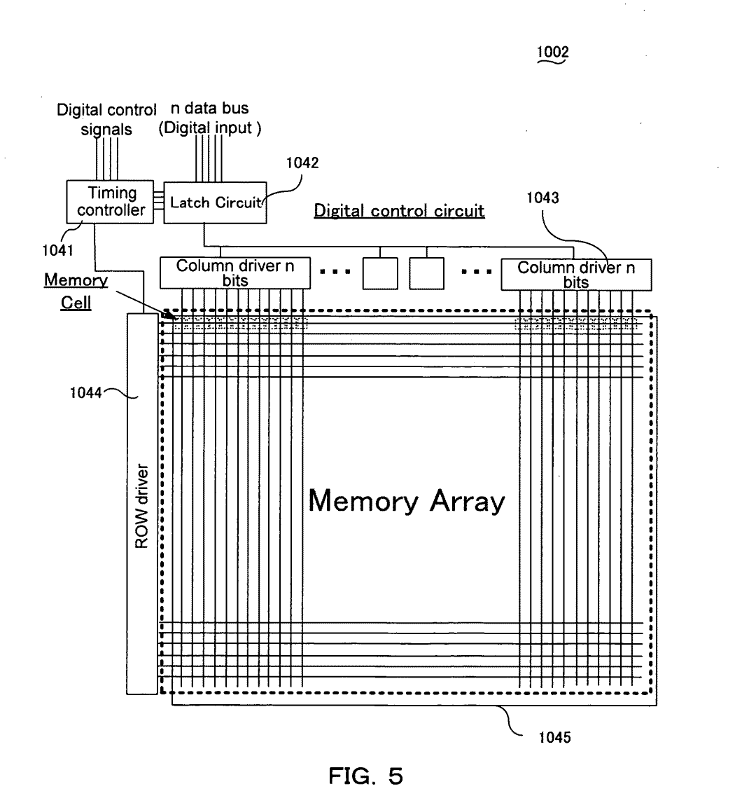

FIG. 3 is a diagram showing an exemplary comprisal of a display apparatus according to a preferred embodiment of the present invention.

As shown in FIG. 3, the display apparatus according to the present embodiment comprises a single spatial light modulator (noted as “SLM” hereinafter) 1002, a total internal reflection (TIR) prism 1003, a projection optical system 1004, a light source optical system 1005, a display processing unit 1006 and frame memory 1007. Here, the SLM 1002 is, for example, a mirror device comprising a plurality of micromirrors.

The SLM 1002 and TIR prism 1003 are place in the optical axis of the projection optical system 1004, and the light source optical system 1005 is placed in a manner so that the optical axis thereof is aligned with that of the projection optical system 1004.

The TIR prism 1003 has the function of causing an illumination light 1008 that is incoming from the light source optical system 1005 placed onto the side to enter the SLM 1002 at a prescribed inclination angle relative thereto as incident light 1009 and causing a reflection light 1010 reflected by the SLM 1002 to transmit itself so as to reach the projection optical system 1004.

The projection optical system 1004 projects the reflection light 1010, as projection light 1011, incoming by way of the SLM 1002 and TIR prism 1003 to a screen 1012 or the like.

The light source optical system 1005 comprises a variable light source 1013 for generating the illumination light 1008, a first condenser lens 1014 for focusing the illumination light 1008, a rod type condenser body 1015 and a second condenser lens 1016.

The variable light source 1013, first condenser lens 1014, rod type condenser body 1015 and second condenser lens 1016 are sequentially placed in the aforementioned order in the optical axis of the illumination light 1008, which is emitted from the variable light source 1013 and incident to the side face of the TIR prism 1003.

The variable light source 1013 includes a red (R) semiconductor light source, a green (G) semiconductor light source and a blue (B) semiconductor light source (which are not shown in a drawing here), which allow independent controls for the light emission states. Note that the semiconductor light source may employ a laser light source, a light emitting diode (LED) or the like. Here, the assumption is that a laser light source is employed. Therefore, the R, G and B laser lights may be used as the illumination light 1008 by causing the R, G and B laser light sources to respectively emit light, and also a synthesized light constituted by two, or more, among the three laser light sources R, G and B, obtained by causing two, or more, of the three laser light sources R, G and B to emit light, may be used as the illumination light 1008. For example, the illumination light 1008 can be changed to a white light by causing the three laser light sources R, G and B to emit light simultaneously. Further, the R, G or B laser light source may be caused to emit light temporally sequentially, or two, or more, among the three laser light sources R, G and B, may be caused to emit light temporally sequentially. With such controls, the display apparatus is enabled to not only carry out a monochrome display but also carry out a color display on the screen 1012 by means of a color sequential method using the single SLM 1002. Incidentally, when a color displaying is performed, an operation is carried out, in which, for example, one frame of displaying data is divided into three sub-frames corresponding to each of colors R, G and B, and the respective laser light sources R, G and B are caused to emit light temporally sequentially in the time bands corresponding to the sub-frames of the respective colors.

The display processing unit 1006 comprises: an image signal processing unit 1017 for processing a continuously inputted video signal 1020; an SLM controller 1018 for controlling the SLM 1002; and a light source controller 1019 for controlling the variable light source 1013.

The frame memory 1007 is the memory used for temporarily storing at least the data of an input video signal in the amount of one frame. The frame memory 1007 is also used as working memory for the image signal processing unit 1017.

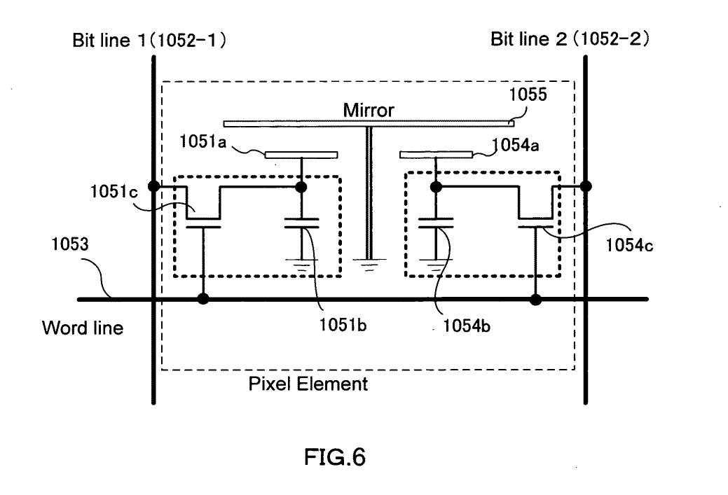

FIG. 4 is a diagram showing another exemplary comprisal of a display apparatus according to the present embodiment.

Memory 1021 is the memory for storing a setup parameter that is used for the purpose of applying a correction process to a video signal 1020 and stores at least a setup value related to gamma correction correcting the characteristic of brightness of the video signal and a setup value such as a parameter for converting the video signal 1020 into a specific color space.

As shown in FIG. 4, the display apparatus of another exemplary comprisal according to the present embodiment further comprises: a color wheel 1031; a motor 1032 for rotating the color wheel 1031; and a motor controller 1033 for controlling the rotation of the motor 1032. Further, the display apparatus also comprises a white light source 1034 in place of a variable light source 1013.

The color wheel 1031 comprises a filter for each of a plurality of colors (e.g., R, G and B), and is equipped between the rod type condenser body 1015 and second condenser lens 1016. Further, the configuration is such that a filter of an individual color is sequentially inserted into the light path of the light source optical system 1005 when the color wheel 1031 is rotated.

The motor controller 1033 is equipped inside of the display processing unit 1006 and the operation timing of the motor controller 1033 is controlled by the SLM controller 1018.

Further, the white light source 1034 is controlled by the light source controller 1019.

Following controlling the white light source 1034 under an emission state with such a comprisal, the rotation of the color wheel 1031 is controlled so as to insert a corresponding color filter into the light path in synchronous with the sub-frame image of the respective colors to be sequentially projected onto the screen 1012 in accordance with the frame signals of the output video signal, and thereby a color display can be attained by means of a color sequential display method.

As described above, the display apparatus according to the present embodiment may be configured as a display apparatus for attaining a color display by means of a color sequential method using the variable light source 1013 capable of individually emitting the lights of the respective colors of a plurality of colors as shown in FIG. 3, or as a display apparatus for attaining a color display by means of a color sequential method using the color wheel 1031 and white light source 1034, which are shown in FIG. 4.

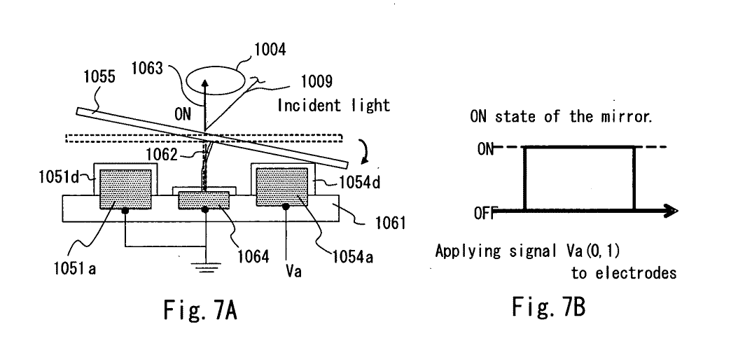

FIG. 5 is a diagram showing an exemplary comprisal of the SLM 1002 comprised in a display apparatus according to the present embodiment.

As shown in FIG. 5, the SLM 1002 comprises a timing controller 1041, a latch circuit 1042, a plurality of column drivers (i.e., Column drivers) 1043, a row driver (i.e., Row driver) 1044 and a pixel element array 1045 in which a plurality of pixel elements is placed in array (noted as “arrayed” hereinafter), and is enabled to determine the brightness of each pixel on the basis of a period of time of driving each respective pixel element under at least one modulation state.

The timing controller 1041 controls the respective operation timing of the latch circuit 1042, column driver 1043 and row driver 1044 in accordance with timing signals (i.e., Digital control signals shown in FIG. 5) output from the SLM controller 1018.

The latch circuit 1042 temporarily retains pixel control data outputted from the SLM controller 1018 with an n data bus intervening and supplies the column driver 1043 with the data.

The pixel element array 1045 comprises a plurality of pixel elements, which are arrayed at the respective positions where the individual bit lines vertically extended from the respective column drivers 1043 cross the individual word lines horizontally extended from the row driver 1044. Further, each pixel element is operated by the column driver 1043 and row driver 1044 driving it.

Meanwhile, the individual pixel element includes a memory cell and therefore the pixel element array 1045 is also defined as including a memory array in which a plurality of memory cells is arrayed, and each pixel element includes a mirror and therefore the pixel element array 1045 is defined as including the mirror array in which a plurality of mirrors is arrayed, as described later in detail. Incidentally, the “column driver” is also called a “bit driver”, while the “row driver” is also called a “word driver”.

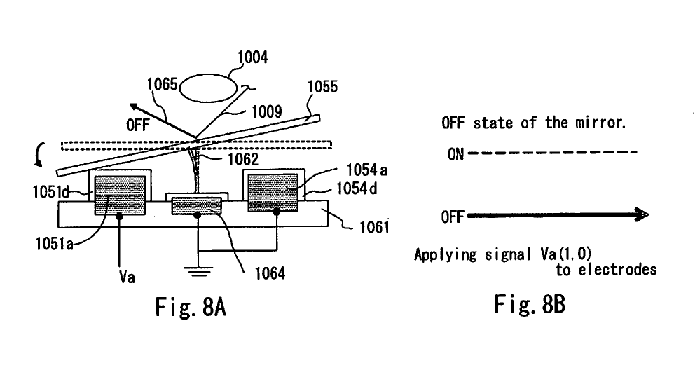

FIG. 6 is a diagram showing an exemplary circuit configuration of an individual pixel unit comprised in the SLM 1002.

As shown in FIG. 6, in each pixel element, an OFF capacitor 1051b is connected to an OFF electrode 1051a, and the OFF capacitor 1051b is connected to a bit line 1052-1 and to a word line 1053 by way of a gate transistor 1051c. Here, the OFF capacitor 1051b and gate transistor 1051c constitute a DRAM-structured memory cell.

Likewise, an ON capacitor 1054b is connected to an ON electrode 1054a, and the ON capacitor 1054b is connected to a bit line 1052-2 and to a word line 1053 by way of a gate transistor 1054c. Here, the ON capacitor 1054b and gate transistor 1054c constitute a DRAM-structured memory cell.

The opening and closing of the gate transistor 1051c and gate transistor 1054c are controlled through the word line 1053.

That is, a horizontal one row of the pixel elements in line with an arbitrary word line 1053 are simultaneously selected, and the charging and discharging of capacitance to and from the OFF capacitor 1051b and ON capacitor 1054b are controlled by way of the bit lines 1052-1 and 1052-2, and thereby the individual ON/OFF and oscillation controls for the mirrors 1055 in the respective pixel units within the present one horizontal row are carried out.

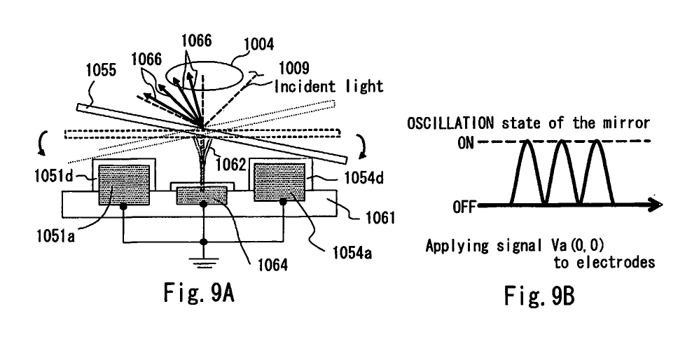

FIGS. 7A, 7B, 8A, 8B, 9A and 9B are diagrams showing exemplary controls for the mirror 1055 of an individual pixel element.

In this example, each pixel element comprises a mirror 1055 freely tiltably supported by a substrate 1061 by way of an elastic hinge 1062 as shown in FIGS. 7A, 8A and 9A.

An OFF electrode 1051a and an OFF stopper 1051d are placed symmetrically across the elastic hinge 1062 on the substrate 1061, and likewise an ON electrode 1054a and an ON stopper 1054d are placed thereon. Note that the mirror 1055 is connected to the ground (GND) by way of the elastic hinge 1062 that comprises a hinge electrode 1064.

Note that, in the following description of the exemplary cases, “Va (0, 1)” means a voltage is not applied to the OFF electrode 1051a and that a designated voltage Va is applied to the ON electrode 1054a. “Va (1, 0)” means a designated voltage Va is applied to the OFF electrode 1051a and that a voltage is not applied to the ON electrode 1054a. “Va (0, 0)” means that a voltage is applied to neither OFF electrode 1051a nor ON electrode 1054a.

FIGS. 7A and 7B are diagrams showing an exemplary ON control for the mirror 1055 of an individual pixel element.

As shown in FIG. 7A, when a voltage 0 volts is applied to the OFF electrode 1051a and a voltage Va volts is applied to the ON electrode 1054a (i.e., Va (0, 1)), the mirror 1055 freely tiltably supported by the substrate 1061 by way of the elastic hinge 1062 is attracted by a Coulomb force generated between the mirror 1055 and ON electrode 1054a and is tilted to a position where the mirror 1055 contacts with the ON stopper 1054d equipped on the ON electrode 1054a. This causes the incident light 1009, which is incident to the mirror 1055, to be reflected to a light path 1063 of the ON position that is aligned with the optical axis of the projection optical system 1004. FIG. 7B shows the quantity of light (also noted as “light quantity” hereinafter) that is projected by means of the ON control.

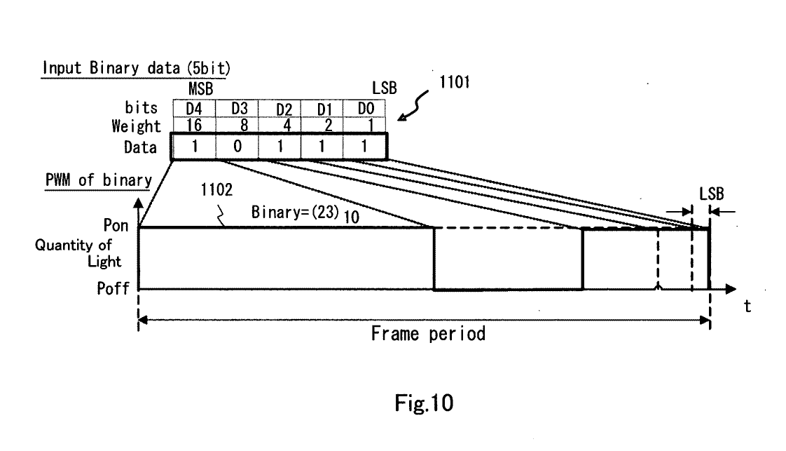

FIGS. 8A and 8B are diagrams showing an exemplary OFF control for the mirror 1055 of an individual pixel element.

As shown in FIG. 8A, when a voltage Va volts is applied to the OFF electrode 1051a and a voltage 0 volts is applied to the ON electrode 1054a (i.e., Va (1, 0)), the mirror 1055 is attracted by a Coulomb force generated between the mirror 1055 and OFF stopper 1051d and is tilted to a position where the mirror 1055 contacts with the OFF stopper 1051d equipped on the OFF electrode 1051a. This causes the incident light 1009, which is incident to the mirror 1055, to be reflected to reflected to a light path 1065 of the OFF position that is shifted from the optical axis of the projection optical system 1004. FIG. 8B shows the light quantity projected by means of the OFF control.

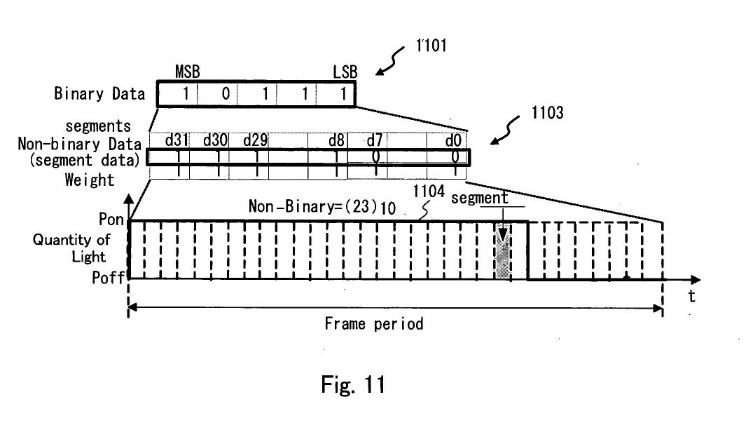

FIGS. 9A and 9B are diagrams showing an exemplary oscillation control for the mirror 1055 of an individual pixel element.

As shown in FIG. 9A, applying a voltage 0 volts to the OFF electrode 1051a and ON electrode 1054a (i.e., Va (0, 0)) when the mirror 1055 is controlled under the OFF state, the Coulomb force generated between the mirror 1055 and OFF electrode 1051a is erased so that the mirror 1055 freely oscillates in accordance with the property of the elastic hinge 1062. This causes the incident light 1009, which is incident to the mirror 1055, to be reflected to a light path 1066 between the light path 1065 of the OFF position that is shifted from the optical axis of the projection optical system 1004 and the light path 1063 of the ON position that matches the optical axis of the projection optical system 1004. In this event, a portion of the light reflected to the light path 1066 and a portion of the diffraction light of the mirror and of scattered light are incident to the projection optical system 1004. As such, the free oscillation of the mirror 1055 makes the overall quantity of light reflected toward the projection optical system 1004 is smaller than the light quantity produced by the mirror 1055 being controlled under the ON state and larger than the light quantity produced by it being controlled under the OFF state, and thereby the overall light quantity is set at an intermediate light quantity between the light quantity produced by the ON control and that produced by the OFF control. FIG. 9B shows the light quantity projected by means of the oscillation control.

Note that the example of the oscillation control describes the case of the mirror 1055 changing over from the OFF control to oscillation control; an alternative control may be such that the mirror 1055 changes over from the ON control to oscillation control.

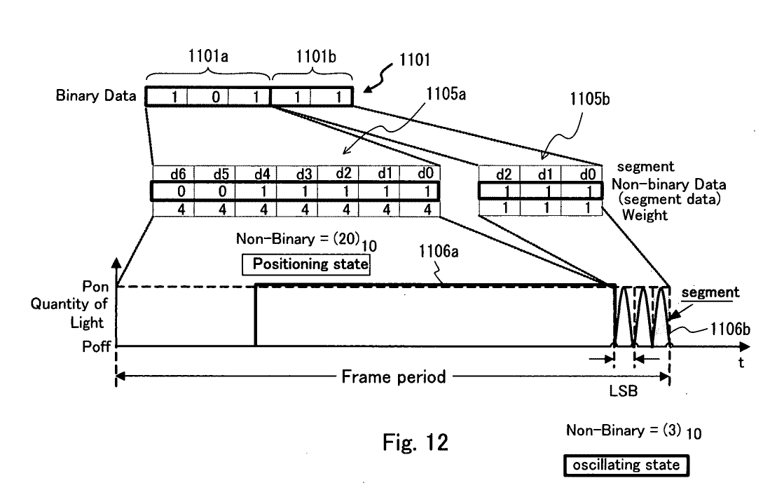

At this point, let it describe binary data and non-binary data, which are two kinds of pixel control data to be used for controlling individual pixel elements, with reference to FIGS. 10, 11 and 12. Note that, for each of FIGS. 10 through 12, the data related to the brightness of individual pixels (i.e., gray scale levels) for each period of input one frame is assumed to be 5-bit binary data for the convenience of description.

When the individual pixel element is controlled with binary data as the pixel control data, the binary data that is the input data is used as the pixel control data.

FIG. 10 is a diagram showing an exemplary control when binary data is used as the pixel control data.

The example shown in FIG. 10 is the case of binary data 1101 that is the input data is used as the pixel control data. The binary data 1101 is data having different weights from the least significant bit (LSB) to the most significant bit (MSB).

A gray scale is expressed by means of a pulse width modulation (PWM) control, the weight of each bit indicates a time width of performing a pulse control, that is, the period of each segment.

The quantity of light projected when the pixel element is controlled in accordance with the binary data 1101 looks like the waveform 1102 indicated by a solid line. In this example, the ON/OFF control for the mirror 1055 is carried out, as shown in FIGS. 7A, 7B, 8A and 8B, with the binary data 1101.

On the other hand, when the individual pixel element is controlled with binary data as the pixel control data, the binary data that is the input data is converted by the SLM controller 1018 into non-binary data that is then used as the pixel control data. Note that “non-binary” data is the data constituted by a bit string in which the weight of two or more bits are equal to each other.

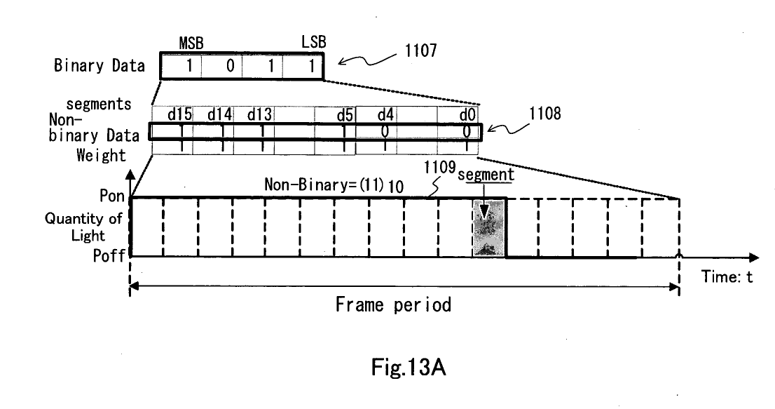

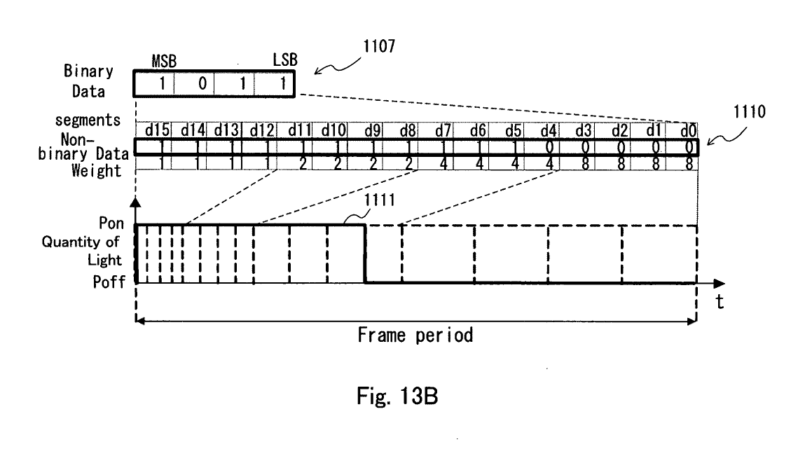

FIGS. 11 and 12 are diagrams showing exemplary controls when such non-binary data is used as the pixel control data.

The example shown in FIG. 11 is the case of converting the entire 5 bits of the binary data 1101, which is the input data, into non-binary data 1103 having a LSB weight (i.e., the weight=1). As shown in FIG. 11, the period of a segment is determined by using a LSB weight (i.e., the weight=1) for the entire 5-bit data of the binary data 1101, which is then converted into non-binary data (i.e., a bit string) 1103 for each segment, and the converted non-binary data is transferred to the SLM 1002. That is, the number of times of ON states in the LSB intervals of the binary data 1101 is calculated, and a gray scale level is expressed so that the period of ON state continues for the equivalence of the bit string. The quantity of light projected when the pixel element is controlled in accordance with the non-binary data 1103 looks like the waveform 1104 indicated by a solid line. In this example, an ON/OFF control for the mirror 1055 is carried out, as shown in FIGS. 7A, 7B, 8A and 8B, using the non-binary data 1103.

The example shown in FIG. 12 is the case of converting the upper 3 bits of the binary data 1101, which is the input data, into non-binary data 1105a having the weight=4, and converting the lower 2 bits into non-binary data 1105b having the LSB weight (i.e., the weight=1). As shown in FIG. 12, the upper 3-bit data 1101a of the binary data 1101 is converted into non-binary data (i.e., a bit string) 1105a for each segment, for which the period of a segment is determined by using a weight=4, and the lower 2-bit data 110ab of the binary data 1101 is converted into non-binary data (i.e., a bit string) 1105b for each segment, for which the period of a segment is determined by using the LSB weight (i.e., the weight=1), and the converter data are transferred to the SLM 1002. The quantities of light projected when a pixel element is controlled in accordance with the non-binary data 1105a and 1105b look like the waveforms 1106a and 1106b, respectively, which are indicated by solid lines and curves, respectively. In this example, an ON/OFF control for the mirror 1055, as shown in FIGS. 7A, 7B, 8A and 8B, is carried out by using the non-binary data 1105a, and an oscillation control for the mirror 1055, as shown in FIGS. 9A and 9B, is carried out by using the non-binary data 1105b.

As described above, the display apparatus according to the present embodiment is enabled to carry out the ON/OFF control for the mirror 1055 of an individual pixel element using the binary data as the pixel control data and carry out the ON/OFF/oscillation control for the mirror 1055 of an individual pixel element using the binary data as the pixel control data.

Further, the display apparatus according to the present embodiment is configured to change the time width of each segment of the non-binary data, which is converted from binary data, using at least two kinds of time widths (i.e., the unit time) when an individual pixel unit is controlled by using non-binary data as the pixel control data, thereby the display apparatus is enabled to change the brightness characteristic of each pixel generated by the SLM 1002.

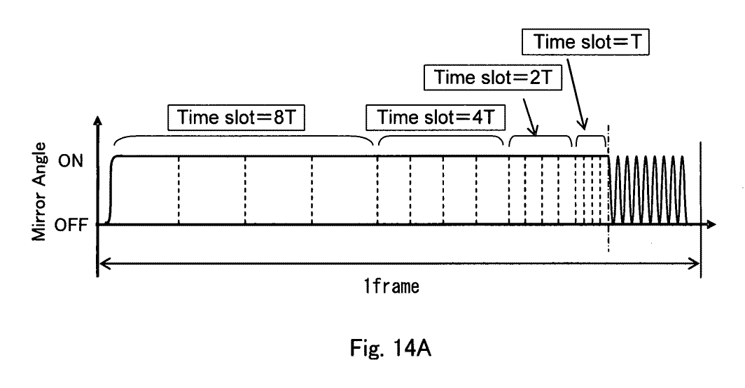

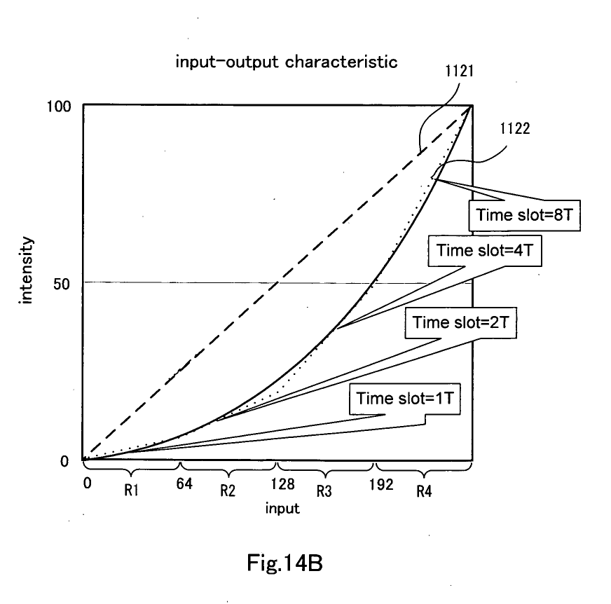

At this point, one of the examples is described with reference to FIGS. 13A and 13B. Note that, for each of FIGS. 13A and 13B, the data related to the brightness of the individual pixels (i.e., gray scale levels) for each period of inputted one frame is assumed to be 4-bit binary data for the convenience of description. Further, the present example calls “segment” as “time slot”.

FIG. 13A is a diagram showing an exemplary control when a pixel element is ON/OFF-controlled by using non-binary data as the pixel control data.

This exemplary control is the case of converting the entire 4 bits of binary data, which is the input data, into non-binary data 1108 in which the time widths of individual segments are the same.

In the case of the present example, the period of a segment is determined by the LSB weight (i.e., the weight=1) for the entire 4-bit data of the binary data 1107 as in the case of the exemplary control shown in FIG. 11, the data is converted into non-binary data (i.e., a bit string) 1108 for each segment and the converted data is transferred to the SLM 1002. The quantity of light projected when a pixel element is controlled in accordance with the non-binary data 1108 looks like the waveform 1109 indicated by a solid line. In this example, an ON/OFF control for the mirror 1055 as shown in FIGS. 7A, 7B, 8A and 8B is carried out using the non-binary data 1108.

FIG. 13B is a diagram showing an exemplary control when a pixel element is ON/OFF-controlled by using non-binary data 1108 of which the time width of each segment is changed.

In the exemplary control, the time width of each segment of the non-binary data 1108 is changed so as to have the segment with a plurality of kinds of time widths. Note that the changing of the time width of each segment of the non-binary data 1108 means changing the weight of each bit included in the bit string of the non-binary data 1108. However, the LSB weight (i.e., the weight=1) of the non-binary data 1108 and the weight=1 of non-binary data in which the weight of each bit has been changed are different in the time widths, although the respective values are the same.

In the exemplary control, the time width of each of segments d12 through d15 is changed to 1T (i.e., the weight of each bit is “1”), the time width of each of segments d8 through d11 is changed to 2T (i.e., the weight of each bit is “2”), the time width of each of segments d4 through d7 is changed to 4T (i.e., the weight of each bit is “4”) and the time width of each of segments d0 through d3 is changed to 8T (i.e., the weight of each bit is “8”). Therefore, the non-binary data 1110 in which the time width of each segment has been changed actually has the segments with four kinds of time widths. The quantity of light projected when a pixel element is controlled in accordance with the non-binary data 1110 looks like the waveform 1111 indicated by a solid line. In this example, the ON/OFF control for the mirror 1055 as shown in FIGS. 7A, 7B, 8A and 8B is carried out by using the non-binary data 1110.

As such, the changing of the time width of each segment of the converted non-binary data 1108 makes it possible to convert the brightness (i.e., the quantity of light) of a pixel generated by the SLM 1002, anticipated by the waveform 1109 in FIG. 13A and the waveform 1111 in FIG. 13B.

The display apparatus according to the present embodiment is configured to employ such a method to be capable of converting the characteristic of the brightness of each pixel generated by the SLM 1002 corresponding to the data value of the brightness of each pixel contained in the input video signal (simply noted as “input/output characteristic” hereinafter), thereby making it possible to carry out the gamma correction as shown in the above described paragraphs (1.1) through (1.3).

The following is a description, in detail, of an input/output characteristic conversion performed in the display apparatus according to the present embodiment.

Note that the following description calls the “segment”, which has been described thus far, as “time slot”. Another assumption is that the control, using non-binary data, for each pixel element for each period of one frame is carried out by a combination of the ON/OFF control and oscillation control as shown in FIG. 12, and that the change of the time width of a time slot is made for the non-binary data in a part used for the ON/OFF control. Further assumption is that each frame period has a period used for an ON/OFF control and a period used for an oscillation control and that the period used for an ON/OFF control is shifted to a period used for an oscillation control at a prescribed changeover time. Further assumption is that, in a period used for the ON/OFF control in each frame period, the ON control is continuously carried out with the above described changeover timing designated as the control end timing. Further assumption is that, in a period used for an oscillation control, the oscillation control is continuously carried out, with the aforementioned changeover timing designated as the control start timing.

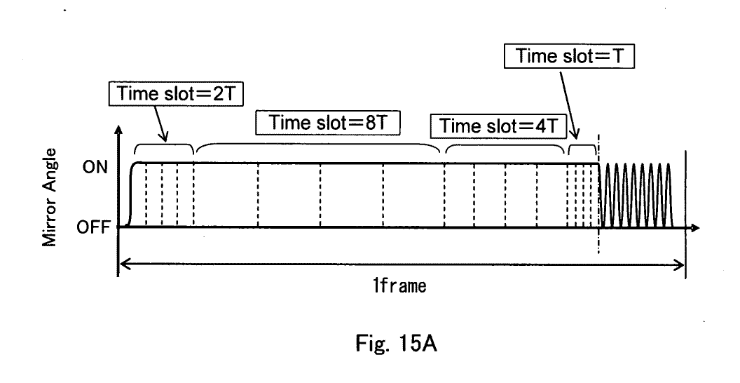

FIGS. 14A and 14B are diagrams for describing an example of performing an input/output characteristic conversion by changing the time width of each time slot of a part of non-binary data for one frame period, that is, the part to be used for an ON/OFF control. FIG. 14A is a diagram showing an exemplary control for the mirror 1055 when the entire bits of a bit string that is non-binary data is designated as “1” and changing the time width of each time slot of non-binary data for the part thereof to be used for an ON/OFF control. FIG. 14B is a diagram showing the input/output characteristics before and after the conversion.

Referring to FIG. 14B, the input/output characteristic 1121 is a linear input/output characteristic before conversion, and is a diagram showing an input/output characteristics when each pixel element is controlled with the time width of each time slot of non-binary data in a part thereof used for an ON/OFF control, as shown in FIG. 12, designated to be the same when the non-binary data is used to control each pixel element.

The input/output characteristic 1122 is an input/output characteristic after the conversion, and is a diagram showing the input/output characteristic when an individual pixel element is controlled by changing the time width of each time slot of non-binary data in a part thereof used for an ON/OFF control.

In this example, a range, which is possibly taken by the value of the data of binary data, in a part thereof to be used for an ON/OFF control, the binary data which is the input data related to the gray scale of each pixel, is divided into four equal parts; each of the quartered ranges (i.e., R1, R2, R3 and R4 shown in FIG. 14B) is equipped with four time slots having the same time width; and four time widths, i.e., T, 2T, 4T and 8T, for each time slot are assigned to the quartered range in ascending order of range of the gray scale level of brightness. That is, a small time width (e.g., T), as a time width for each time slot, is assigned to the range representing a low brightness gray scale level (e.g., R1), and a larger time width (e.g., 2T), as a time width for each time slot, is assigned to the range representing the next higher brightness gray scale level (e.g., R2).

With this, when the input data is converted into non-binary data and a pixel element is controlled by using the non-binary data,

the time width of each time slot included in the data of a part corresponding to the above described R1 is designated as T,

the time width of each time slot included in the data of a part corresponding to the above described R2 is designated as 2T,

the time width of each time slot included in the data of a part corresponding to the above described R3 is designated as 4T, and

the time width of each time slot included in the data of a part corresponding to the above described R4 is designated as 8T,

among the data of the non-binary data in a part to be used for an ON/OFF control, and thereby the pixel element is controlled. In this case, the time width of each time slot in a period to be used for an ON/OFF control for the period of one frame is as shown in FIG. 14A.

In this example, a small time width, as a time width for each time slot, is assigned to the input data in a range representing a low brightness gray scale level and thereby degradation in the image quality of a displaying video image that represents a low brightness gray scale level can be prevented.

As described above, the changing of the time width of each time slot of the data of non-binary data, in a part thereof to be used for an ON/OFF control, makes it possible to convert the input/output characteristic.

Note that the example described with reference to FIGS. 14A and 14B is configured to quarter a range that is possibly taken by the data value of the input data in a part to be used for an ON/OFF control and to assign, in ascending order of range of the gray scale level of brightness, T, 2T, 4T and 8T to the quartered range as the time widths for each time slot; alternatively, it is also possible to assign time widths in a combination that is different from the aforementioned.

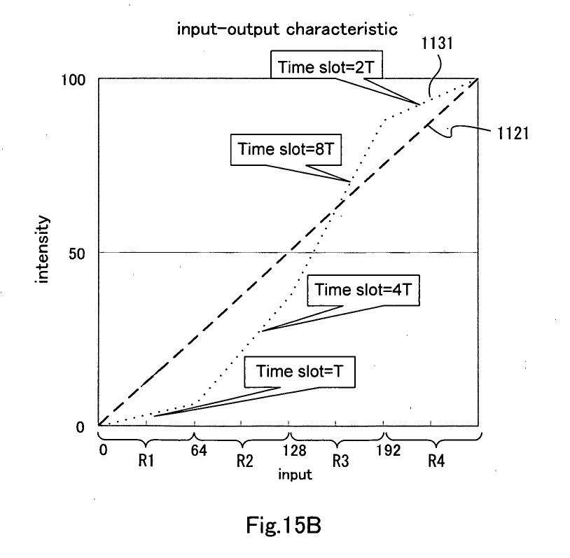

For example, it is possible to assign, in ascending order of range of the gray scale level of brightness, T, 4T, 8T and 2T to the quartered ranges as the time widths for each time slot, as shown in FIGS. 15A and 15B. Assigning a different combination of time widths as described above of course makes it possible to obtain an input/output characteristic 1131 that is different from the input/output characteristic 1122 shown in FIG. 14B.

Further, the example described with reference to FIGS. 14A and 14B is configured to quarter a range that is possibly taken by the data value of the input data in a part thereof to be used for an ON/OFF control and to provide each of the quartered ranges with four time slots having the same time width; it is alternatively possible to provide each of the quartered ranges with a plurality of time slots having the same time width, the plurality that is different from four.

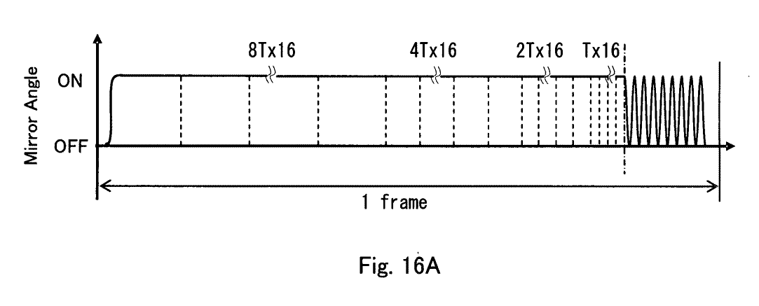

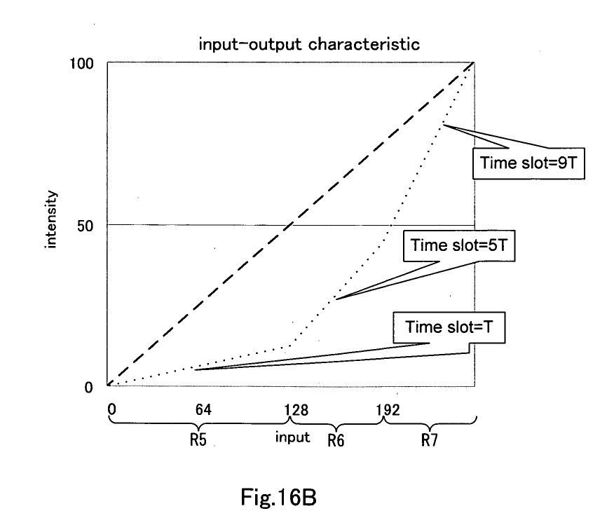

For example, it is possible to provide each of the quartered ranges with 16 time slots having the same time width and to assign, in ascending order of range of the gray scale level of brightness, T, 2T, 4T and 8T as the time width for each time slot to the quartered range, as shown in FIG. 16A. The individual time widths, i.e., T, 2T, 4T and 8T, are of course smaller than the respective time widths, i.e., T, 2T, 4T and 8T, shown in FIG. 14A. The shortening of the time width for each time slot and the increasing of the number of time slots make it possible to increase the number of expressible gray scale levels while maintaining the input/output characteristic 1122 shown in FIG. 14B.

Further, the example described with reference to FIGS. 14A and 14B is configured to quarter a range that is possibly taken by the data value of the input data in a part thereof to be used for an ON/OFF control and to provide each of the quartered ranges with four time slots having the same time width; it is alternatively possible to divide into a plurality of ranges in a different method and to provide each range with a plurality of time slots having the same time width.

For example, it is possible to trisect a range that is possibly taken by the data value of the input data in a part thereof to be used for an ON/OFF control and to provide each of the trisected ranges (i.e., R5, R6 and R7 shown in FIG. 16B) with a plurality of time slots having the same time width, as shown in FIG. 16B.

Note that this example is configured to assign T, 5T and 9T in ascending order of range of the gray scale level of brightness as the time widths for each time slot, and also to increase the number of time slots for the data in a range representing a low gray scale level of brightness (e.g., the data in the range representing the gray scale level having the intensity of 50 or less) and decrease the number of time slots for the data in a range representing a high gray scale level of brightness (e.g., the data in the range representing the gray scale level having the intensity of 50 or more).

Further in this example, the total number of time slots provided for a range representing a low gray scale level of brightness (e.g., R5) is larger than that of time slots provided for a range representing a gray scale level of brightness that is higher than the aforementioned level (e.g., R6) in the trisected ranges and accordingly this example is configured such that the number of times of controlling a pixel element using the time width (e.g., T) of a time slot equipped for a range representing a low gray scale level of brightness (e.g., R5) is larger than the number of times of controlling a pixel element using the time width (e.g., 5T) of a time slot equipped for a range representing a gray scale level of brightness (e.g., R6) that is higher than the aforementioned level.

Further, this example is configured such that the time width (e.g., T) of each time slot provided for a range representing a low gray scale level of brightness (e.g., R5) is smaller than the time width (e.g., 5T) of another kind of time slot used by combining a time slot having the time width (e.g., T) in the trisected ranges when a pixel element is controlled in accordance with the data of a range (e.g., R6) representing a gray scale level of brightness that is higher than the aforementioned level.

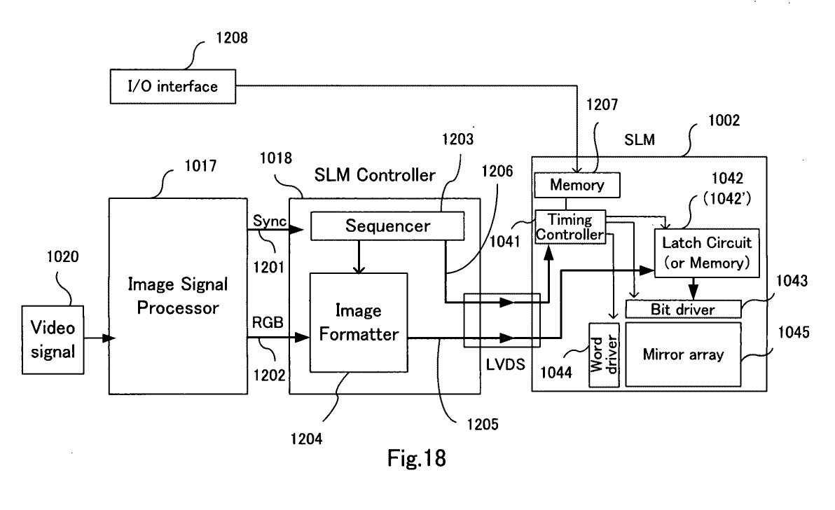

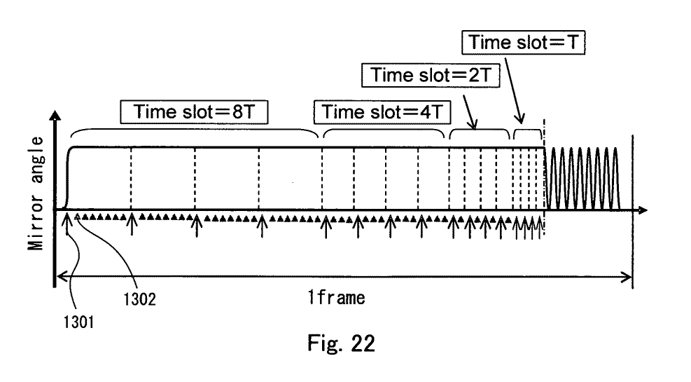

Here, the various setup values and parameters for attaining the displaying characteristics used in the description for FIGS. 14A through 16B are stored in the memory 1021 shown in FIGS. 3 and 4, or in the memory 1207 shown in FIGS. 18 and 21 (which are described later).

Alternatively, it is possible to perform a control by dividing one frame into a plurality of sub-frames. In such a case, each frame of continuously inputted video signals is divided into a plurality of sub-frames, and pixel control data (i.e., non-binary data) is generated on the basis of the video signal of the plurality of sub-frames.

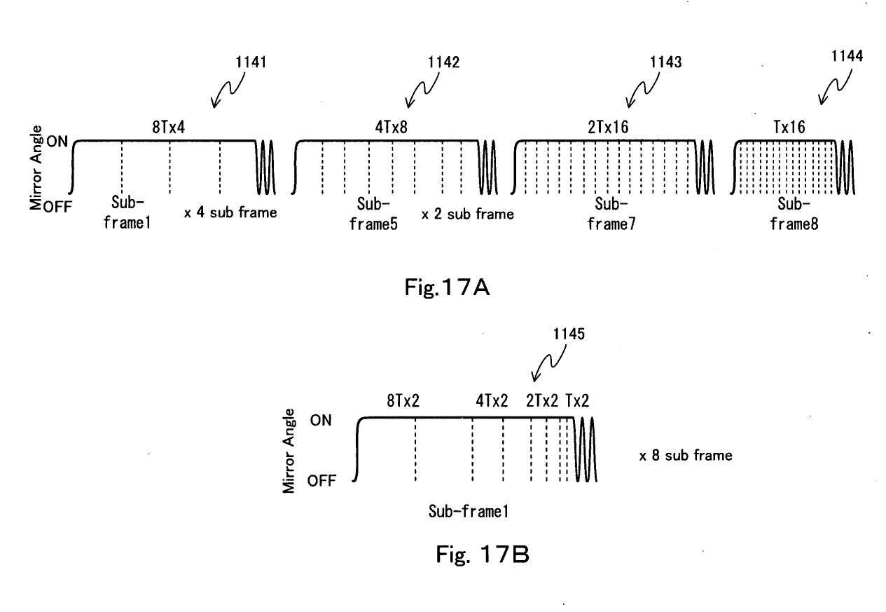

FIGS. 17A and 17B exemplify the case of dividing one frame into a plurality of sub-frames in the example shown in FIG. 16A.

The example shown in FIG. 17A is the case of dividing one frame into four sub-frames 1141 including four time slots having the time width of 8T, two sub-frames 1142 including eight time slots having the time width of 4T, one sub-frame 1143 including sixteen time slots having the time width of 2T and one sub-frame 1144 including sixteen time slots having the time width of T.

As such, a control can be carried out by dividing one frame into a plurality of sub-frames so that the time widths of time slots to be same and used for an ON/OFF control within each sub-frame period.

The example shown in FIG. 17B is the case of dividing one frame into eight sub-frames 1145 including two each of the time slots having time widths of 8T, 4T, 2T and T, respectively. As such, one frame can be divided into a plurality of sub-frames for use in a control so that time slots having respectively different time widths as the time slots to be used for an ON/OFF control are included and so that the sub-frames included within the period of one frame have the same control pattern, within each sub-frame period.

Next is a description, in detail, of a comprisal enabled to attain such an input/output characteristic.

FIG. 18 is a diagram showing an exemplary partial comprisal included in a display apparatus according to the present embodiment.

In the exemplary comprisal shown in FIG. 18, an image signal processing unit 1017 is configured to apply, for example, an analog to digital (A/D) conversion process and a resolution conversion process on an as required basis, and also to generate a frame synchronous signal (Sync) 1201 on the basis of the input video signal 1020 and generate a video signal 1202 in accordance with the display aspect (e.g., color display, monochrome display or others). For example, the image signal processing unit 1017 generates the video signals of R, G and B and the like when the color display is carried out.

An SLM controller 1018 comprises a sequencer 1203 and an image formatter 1204.

The sequencer 1203 controls the respective operation timing of the image formatter 1204, SLM 1002 and light source controller 1019 (refer to FIG. 3) in accordance with the frame synchronous signal 1201 output from the image signal processing unit 1017. Further, the sequencer 1203 is also capable of controlling the operation timing of a motor controller 1033 (refer to FIG. 4).

The image formatter 1204 generates, and outputs, pixel control data 1205, which is display-use data (Video data) for the SLM 1002, on the basis of the video signal 1202 output from the image signal processing unit 1017.

Note that, while the display apparatus according to the present embodiment is configured to enable the image formatter 1204 to generate binary data or non-binary data as the pixel control data, the present exemplary comprisal is configured to generate non-binary data as the pixel control data. The non-binary data generated by the image formatter 1204, however, is data assumed to obtain a linear input/output characteristic as in the case of the input/output characteristics 1121 shown in FIG. 14B. Note that the pixel control data generated as non-binary data is generated on the basis of a non-binary video signal that is obtained by converting an input binary video signal into a non-binary video signal. Incidentally, the present exemplary comprisal assumes, for the convenience of description, that the display form is monochrome display and that non-binary data including two kinds thereof, i.e., data used for an ON/OFF control and data used for an oscillation control, as shown in, for example, the above described FIG. 12, are generated as the pixel control data 1205 per frame. Further, the present exemplary comprisal assumes that the data corresponding to each time slot is repetitively output from the image formatter 1204 for every minimum control unit time T_min within the period of each time slot of the non-binary data when the image formatter 1204 outputs the generated non-binary data.

The SLM 1002 is connected to the SLM controller 1018 by way of a transmission path that is compatible to the Low-Voltage Differential Signaling (LVDS) standard, and comprises a timing controller 1041, a latch circuit 1042, a bit driver (column driver) 1043, a word driver (row driver) 1044, a pixel element array 1045 and memory 1207. Note that FIG. 18 shows the plurality of column drivers 1043 shown in FIG. 5 as a single, bit driver 1043. Further, the SLM 1002 is also connected to an input/output (I/O) interface 1208.

The memory 1207 pre-stores the setup values (e.g., the above described T, 2T, 4T and 8T) of the time widths of each time slot of non-binary data, in the part thereof to be used for an ON/OFF control, or the setup values (e.g., the above described T, 2T, 4T and 8T; T, 4T, 8T and 2T, or the like) of a combination of the time widths of the individual time slots. The setup values of the time widths of individual time slots, however, are no smaller than the above described minimum control unit time T_min.

The setup value stored in the memory 1207 is selectable from the outside by way of the I/O interface 1208, and the selected setup value is set as the time width of individual time slot of non-binary data, in a part thereof to be used for an ON/OFF control. That is, the time width of the individual time slot is changed in accordance with the selected setup value.

This configuration enables a user, by selecting a desired setup value from among a plurality of setup values stored in the memory 1207, to set a selected setup value as the time width of each time slot of non-binary data, in a part thereof to be used for an ON/OFF control and to perform an input/output characteristic conversion in the SLM 1002 according to the present exemplary comprisal.

The timing controller 1041 controls the respective operation timing of the latch circuit 1042, bit driver 1043 and word driver 1044 on the basis of the setup value selected from among the plurality of setup values stored in the memory 1207. The latch circuit 1042 separates the pixel control data for one line of pixels in accordance with the display timing into plural pieces of data, and retains the separated data, from the pixel control data 1205 that is continuously inputted from the image formatter 1204, and output the separated data to the bit driver 1043.

Note that the display timing corresponds to the start timing of each time slot of the non-binary data. Therefore, when the time width of each time slot of the non-binary data, in a part thereof to be used for an ON/OFF control is changed on the basis of the selected setup value as described above, the display timing is also changed associated with the change.

The bit driver 1043 outputs data corresponding to the pixel control data for the amount of one line of pixels input from the latch circuit 1042 to a bit line in accordance with the display timing. The word driver 1044 outputs a control signal to a word line in synchronous with the aforementioned outputting.

With this operation, the data corresponding to the pixel control data for the amount of one frame corresponding to the display timing is written to the memory cell of the respective pixel elements for the corresponding one line of pixels, and the aforementioned pixel elements are controlled. Further, such operation is carried out for the amount of one frame corresponding to the display timing, and thereby the entire pixel elements corresponding to one-time display timing are controlled.

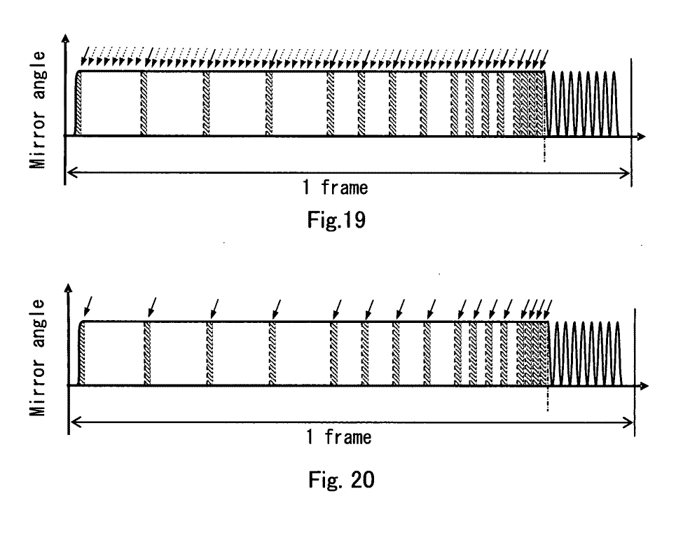

FIG. 19 is a diagram showing exemplary display timing in a period used for an ON/OFF control within one frame period in the present exemplary comprisal. Note that FIG. 19 is also a diagram showing an exemplary control that is the same as the exemplary control shown in FIG. 14A.

Referring to FIG. 19, each diagonal arrow corresponds to the timing of the above described minimum control unit time T_min. That is, at the timing indicated by each arrow, the image formatter 1204 outputs, for one time, the data of a time slot corresponding to the generated non-binary data to the latch circuit 1042. Further, in each arrow, a solid line arrow indicates the display timing changed on the basis of the above described selected setup value, while a dotted line arrow indicates the timing that is other than the display timing. Therefore, only the data (i.e., the data corresponding to the shaded part in FIG. 19) corresponding to the display timing indicated by the solid line arrow is retained by the latch circuit 1042, while the data corresponding to other timing will not be retained by the latch circuit 1042.

As described above, the present exemplary comprisal is configured such that the latch circuit 1042 retains the pixel control data for the amount of one frame corresponding to the display timing on the basis of the above described setup value, part by part, and such that it does not retain pixel control data corresponding to the timing other than the aforementioned display timing, and therefore the time width of each time slot of the pixel control data (non-binary data) 1205 generated by the image formatter 1204, in a part of the non-binary data to be used for an ON/OFF control, is changed and an input/output characteristic conversion is enabled.

Note that the present exemplary comprisal is configured such that the latch circuit 1042 divides the pixel control data for the amount of one line of pixels corresponding to the display timing into a plurality of parts, and retains them; an exemplary alternative configuration may be such that the pixel control data for the amount of one line of pixels corresponding to the display timing is retained at once.

Further, the present exemplary comprisal may be configured to include a plurality of latch circuits 1042. In such a case, the configuration is such that the individual latch circuit 1042 retains a part of the pixel control data for the amount of one line of pixels corresponding to the display timing so as to make it possible to retain, at once, the pixel control data for the amount of one line of pixels corresponding to the display timing.

Further, the present exemplary comprisal may be configured to equip memory (i.e., a memory circuit) 1042′ capable of retaining the entirety, or part, of the pixel control data for the amount of one frame, in place of equipping the latch circuit 1042.

In such a case, the memory 1042′ retains, at once or by divided into a plurality of parts, the pixel control data for the amount of one frame in accordance with the display timing on the basis of the pixel control data 1205 that is the non-binary data continuously inputted from the image formatter 1204 and output to the bit driver 1043 by the pixel control data for the amount of one line of pixels. The bit driver 1043 outputs the data corresponding to the pixel control data for the amount of one line of pixels input from the memory 1042′ to a bit line in accordance with the display timing. The word driver 1044 outputs a control signal to the word line in synchronous with the aforementioned outputting. With this operation, the data corresponding to the pixel control data for the amount of one frame in accordance with the display timing is written to a memory array (i.e., the pixel element array 1045) by the pixel control data for the amount of one line of pixels, and thereby the entire pixel elements corresponding to one time of display timing are controlled.

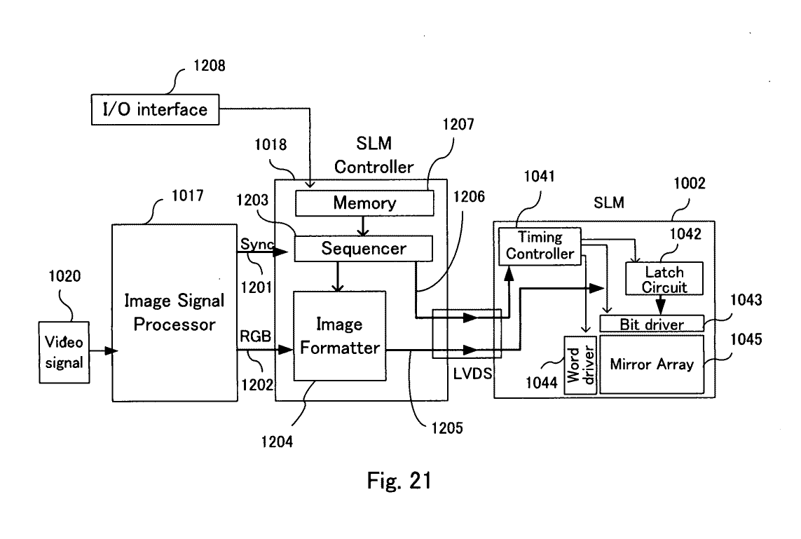

FIG. 20 is a diagram showing exemplary display timing in a period used for an ON/OFF control within one frame period in such exemplary comprisal. Note that FIG. 20 is also a diagram showing an exemplary control that is the same as the exemplary control shown in FIG. 14A.

Referring to FIG. 20, a diagonal solid line arrow indicates the display timing changed on the basis of the selected setup value described above, likewise the case shown in FIG. 19, and the data (i.e., the data corresponding to the diagonally shaded part as shown in FIG. 20) corresponding to the display timing indicated by the solid line arrow will actually be retained in the memory 1042′

Also in the exemplary comprisal equipped with the memory 1042′, in place of the latch circuit 1042, the time width of each time slot of the pixel control data (non-binary data) 1205 generated by the image formatter 1204, in a part of the aforementioned data to be used for an ON/OFF control, is changed as described above, and thereby it is possible to carry out an input/output characteristic conversion.

Note that the exemplary comprisal described with reference to FIGS. 18 through 20 is configured to change, at the SLM 1002, the time width of each time slot of the pixel control data (non-binary data) 1205 generated by the image formatter 1204, in a part of the aforementioned data to be used for an ON/OFF control; alternatively, the change may be carried out at the SLM controller 1018.

FIG. 21 is a diagram showing an exemplary partial comprisal included in a display apparatus according to the present embodiment, and is a diagram corresponding to the above described FIG. 18.

As shown in FIG. 21, the present exemplary comprisal is configured to equip inside of the SLM controller 1018 with the memory 1207 equipped in the SLM 1002 (shown in FIG. 18) and connect an I/O interface 1208 to the SLM controller 1018. This configuration enables the user to select a desired setup value from among a plurality of setup values stored in the memory 1207 by operating the I/O interface 1208, as in the case of the exemplary comprisal shown in FIG. 18.

Further, the present exemplary comprisal is configured such that the sequencer 1203 controls the respective operation timing of the image formatter 1204, SLM 1002 and light source controller 1019 (refer to FIG. 3) on the basis of the frame synchronous signal 1201 and of the setup value selected from among a plurality of setup values stored in the memory 1207. Further, the sequencer 1203 is also capable of controlling the operation timing of the motor controller 1033 (refer to FIG. 4).

The image formatter 1204 converts the inputted binary video signal into a non-binary video signal under the sequencer 1203 controlling the operation timing and generates pixel control data, which is non-binary data, on the basis of the non-binary video signal.

Here, the control of the operation timing of the image formatter 1204 performed by the sequencer 1203 is devised such that the time width of each time slot of the non-binary data generated by the image formatter 1204, in a part of the data to be used for an ON/OFF control, is equal to the time width in accordance with the above described selected setup value. This configuration enables the image formatter 1204 to generate non-binary data including a time slot having the time width in accordance with the above described selected setup value.

Further, when outputting the generated non-binary data under the sequencer 1203 controlling the operation timing, the image formatter 1204 repetitiously outputs the data of the corresponding time slot at each of the above described minimum control unit time T_min during the time width of the individual time slot. Therefore, for a time slot having a time width that is two times, or more, of the minimum control unit time T_min, the same data is actually repetitiously output in a plurality of times.

Further, the present exemplary comprisal is configured such that the timing controller 1041 controls the respective operation timing of the latch circuit 1042, bit driver 1043 and word driver 1044 on the basis of the timing signal (Address data and Clock signal) 1206 output from the sequencer 1203. In this event, the timing controller 1041 controls the aforementioned operation timing so as to write, to the memory array (i.e., the pixel element array 1045), the data on the basis of the pixel control data (non-binary data) for the amount of one frame that is output from the image formatter 1204 at every minimum control unit time T_min. This control causes the data in accordance with the pixel control data (non-binary data) for the amount of one frame to be written to the memory array at every minimum control unit time T_min.

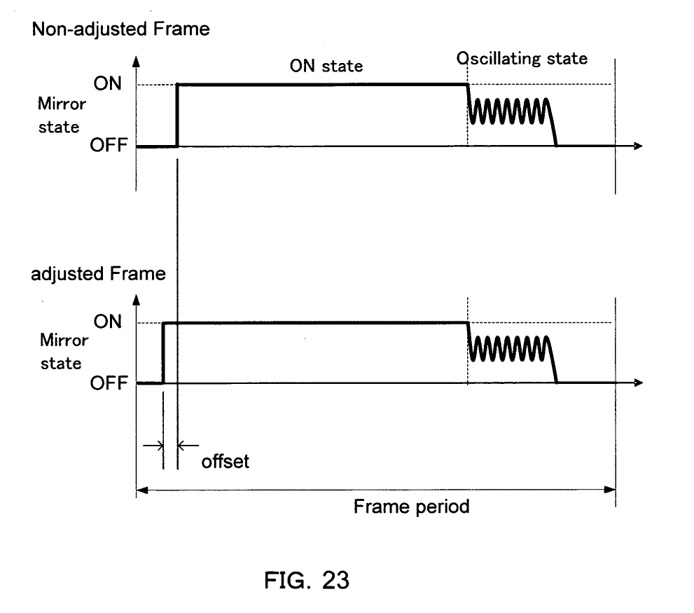

FIG. 22 is a diagram showing exemplary data-write timing for writing to a memory array in a period used for an ON/OFF control within one frame period, in the present exemplary comprisal. Note that FIG. 22 is also a diagram showing an exemplary control that is the same as the exemplary control shown in FIG. 14A.

Referring to FIG. 22, each arrow 1301 and each triangular mark 1302 show write timing at each of the above described minimum control unit time T_min. As described above, in the time width of each time slot of non-binary data, the data of the respectively corresponding time slots are repetitiously output from the image formatter 1204 at every minimum control unit time T_min so that the corresponding pieces of data are repetitiously written to the memory array. Therefore, in the time width of each respective time slot, the arrow 1301 indicating the timing at which the write timing at every minimum control unit time T_min matches the start timing for a time slot also constitutes a mark indicating the timing at which the data of the time slot is overwritten, while the triangular mark 1302 constitutes a mark indicating the timing at which the memory array is refreshed.

As described above, the present exemplary comprisal is configured to refresh the memory array at every minimum control unit time T_min in the time width of each time slot, thereby enabling each memory cell to correctly retain data regardless of the size of the time width of the time slot. It also makes it possible to shorten a data retention time for one time of the data write at each memory cell and accordingly configure each memory cell more compact with the capacitor capacitance thereof.

Note that, in the exemplary comprisals described with reference to FIGS. 18 through 22, the minimum control unit time T_min can be determined on the basis of the specification of the memory array.

Meanwhile in the exemplary comprisals described with reference to FIGS. 18 through 22, it is possible to perform a control by dividing each frame into a plurality of sub-frames as shown in FIGS. 17A and 17B, as an example. In this case, the configuration is such that the image formatter 1204 divides each frame of continuously inputted video signal into a plurality of sub-frames under the sequencer 1203 controlling the operation timing and generates pixel control data that is non-binary data during each sub-frame period on the basis of the video signal of the plurality of sub-frames. Further in this case, the time width of a time slot of the non-binary data in each sub-frame period can be changed either at the SLM 1002 or SLM controller 1018 in the same manner as described above. Further, when such a control is carried out, it is also possible to store, in the memory 1207, a setup value to be used for performing a control by dividing each frame into a plurality of sub-frames.

Further, the exemplary comprisals described with reference to FIGS. 18 through 22 are configured to enable the user to freely select a desired setup value from among a plurality of setup values stored in the memory 1207 by operating the I/O interface 1208; alternatively, it is of course possible to make the setup value a fixed value. In such a case, the memory 1207 and I/O interface 1208 can be eliminated.

Further, the exemplary comprisals described with reference to FIGS. 18 through 22 may also be configured as follows. That is, an alternative configuration is such that, in order to enable the SLM controller 1018 or SLM 1002 to adjust the brightness of a video image, which is obtained by modulating each pixel element of the SLM 1002, with a predetermined adjustment value, a modulation control time in accordance with the adjustment value is added to, or subtracted from, the modulation control time of the individual pixel element of the SLM 1002 during the period of one frame.

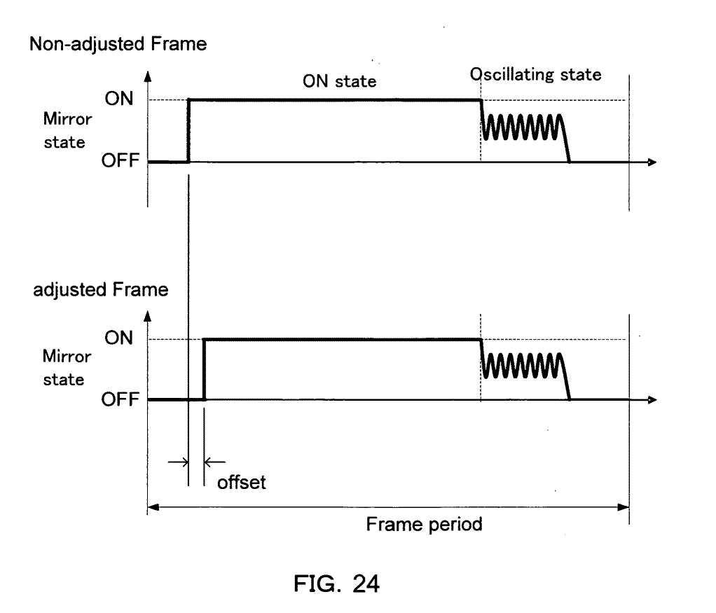

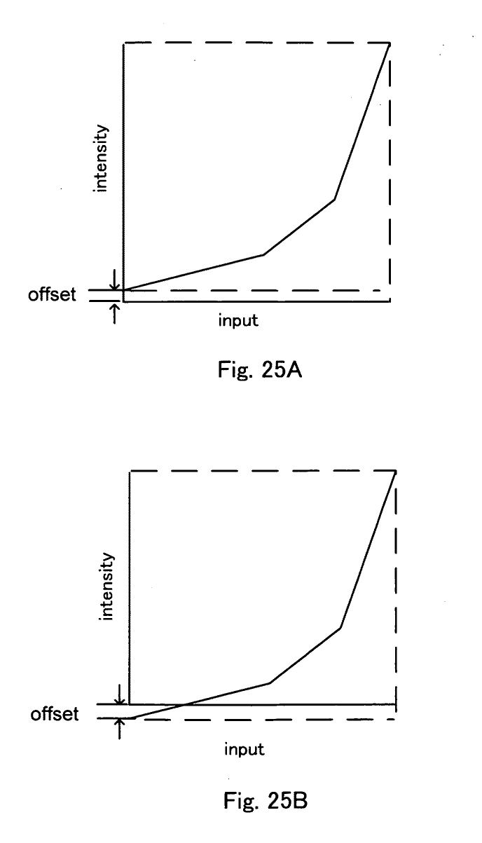

FIGS. 23 and 24 are diagrams each showing an exemplary control for a pixel element for each period of one frame when configuring as noted above.

FIG. 23 is a diagram showing an exemplary control when configuring so as to add a modulation control time in accordance with an adjustment value to the modulation control time of the individual pixel element of an SLM 1002 within the period of one frame.

Referring to FIG. 23, the upper part of the figure shows an exemplary control before (i.e., pre-adjustment) a modulation control time in accordance with an adjustment value is added; while the lower part shows an exemplary control after (i.e., post-adjustment) a modulation control time in accordance with an adjustment value is added. Further, “offset” indicated in the lower part shows the modulation control time in accordance with the adjustment value.

In the example shown in FIG. 23, the time for an ON control by the amount in accordance with the adjustment value (i.e., “offset”) is added in a period used for the ON/OFF control during the period of one frame.

FIG. 24 is a diagram showing an exemplary control when configuring so as to subtract a modulation control time in accordance with an adjustment value from the modulation control time period of the individual pixel element of an SLM within the period of one frame.

Referring to FIG. 24, the upper part of the figure shows an exemplary control before (i.e., pre-adjustment) a modulation control time in accordance with an adjustment value is subtracted; while the lower part shows an exemplary control after (i.e., post-adjustment) a modulation control time in accordance with an adjustment value is subtracted. Further, “offset” indicated in the lower part shows the modulation control time in accordance with the adjustment value.

In the example shown in FIG. 24, the time for an ON control by the amount in accordance with the adjustment value (i.e., “offset”) is subtracted in a period used for the ON/OFF control during the period of one frame.

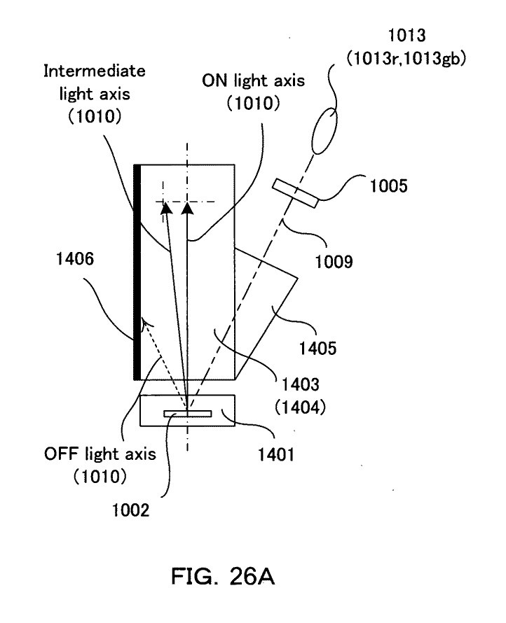

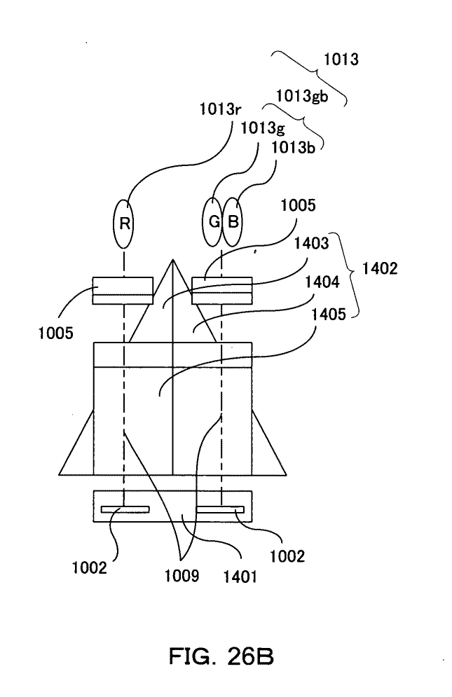

FIG. 25A is a diagram showing an exemplary input/output characteristic obtained by configuring so as to add a modulation control time in accordance with an adjustment value as in the exemplary control shown in FIG. 23.

As shown in FIG. 25A, the input/output characteristic is now a characteristic so that the amount of a light quantity (i.e., “offset” in FIG. 25A) corresponding to the modulation control time in accordance with the adjustment value has been added to the light quantity obtained for the input data, and therefore the brightness of the video image obtained by modulating the individual pixel elements of the SLM 1002 can be adjusted to be higher (i.e., brighter).

FIG. 25B is a diagram showing an exemplary input/output characteristic obtained by configuring so as to subtract a modulation control time in accordance with an adjustment value as in the exemplary control shown in FIG. 24.

As shown in FIG. 25B, the input/output characteristic is now a characteristic so that the amount of a light quantity (i.e., “offset” in FIG. 25A) corresponding to the modulation control time in accordance with the adjustment value has been subtracted from the light quantity obtained for the input data, and therefore the brightness of the video image obtained by modulating the individual pixel elements of the SLM 1002 can be adjusted to be lower (i.e., darker).

As described above, the exemplary configurations described with reference to FIGS. 23 through 25A, 25B adjust the brightness by adding or subtracting a modulation control time, thereby eliminating a sacrifice in the number of gray scale levels as seen in the case of adjusting the brightness by means of a data exchange. Further, when adding or subtracting a modulation control time, the brightness can be adjusted without a need to modify the output data relative to the input data. Note that the adjusting of the brightness is also a black level offset adjustment.

That is, the exemplary comprisals described with reference to FIGS. 23 through 25A, 25B may also be configured to implement the operation of adding or subtracting a modulation control time in accordance with the adjustment value to or from the modulation control time of the individual pixel element of the SLM 1002 during the period of one frame as described above, so that the level of brightness of a video image displayed on the display apparatus becomes a desired level of brightness when the inputted video signal is, for example, the data in a gray scale level representing an approximate black.

Further, the exemplary comprisals described with reference to FIGS. 23 through 25A, 25B are configured to add or subtract a modulation control time in accordance with the adjustment value to or from the modulation control time of each pixel element of the SLM 1002 in a period used for an ON/OFF control within the period of one frame; it is alternatively possible to carry out such operation, for example, in a period used for an oscillation control during the period of one frame, or to carry out such operation in both periods, that is, a period used for the ON/OFF control and that used for the oscillation control, within the period of one frame.

Further, the exemplary comprisals described with reference to FIGS. 23 through 25A, 25B may also be configured to enable the user to freely set the above described adjustment value. In such a case, an exemplary configuration may be so as to equip a user interface allowing the user to operate and to allow the user to determine the above described adjustment value through an operation on the interface.

Further, the exemplary comprisals described with reference to FIGS. 23 through 25A, 25B may also be configured such that the above described setup value is set for a control corresponding to each pixel constituting an image or corresponding to each of a plurality of regions constituting an image. In such a case, the brightness of each pixel or region can be adjusted in such a manner as to correct non-uniformity in the brightness of a displayed video image, the non-uniformity attributable to the diffuse light generated within an optical device comprised in the display apparatus.

The setup information stored in the memory 1021 or memory 1207 includes: the number of divisions determining how many divisions a range possibly taken by the value of data in a part of input data, the part thereof to be used for an ON/OFF control, is to be equally divided into;

the number of time slots determining how many time slots having the same time width are to be provided for each of the equally divided range; and
the value of a time width included in each time slot, as seen in the example described with reference to, for example, FIGS. 14A and 14B; and in addition,
the value of a black level offset adjustment as seen in the exemplary comprisal described with reference to FIGS. 23 through 25.

A combination of these setup values can be changed in accordance with, for example, the user setup, with the characteristic of the brightness of an inputted video signal and with the detected value of the brightness of the environment where the apparatus is placed.

The present embodiment simply designates the above described number of divisions and the number of time slots as small numbers for a convenience of description; a display apparatus implementing the present embodiment may of course be configured to use a larger number of divisions and that of time slots, thereby attaining a higher level of gray scale representation. In such a case, the more the kind and the number to be corrected, the more the number of setup values and the volume of parameters, which are to be stored in the memory 1021 or memory 1207, become, requiring the storage space of the memory 1021 or 1207 to be increased. This problem likewise occurs in the conventional method of using a memory lookup table to select, and output, an output word from the words of inputted digital data.

In order to lighten the volume of setup values to be stored in the memory, the present embodiment is configured to use the setup values for attaining the input/output characteristic 1122 as shown in FIG. 14B, i.e., the number of divisions, the number of time slots and the time width included in each time slot, as a reference value, and to store only the respective differences from the reference values for the setup values for attaining another input/output characteristic, i.e., the number of divisions, the number of time slots and the time width included in each time slot. This configuration stores a relative difference value in place of the absolute values of each setup value, thereby making it possible to lighten the volume of the values to be stored.

Note that the present example uses the input/output characteristic 1122, which is the input/output characteristic in order to remove the gamma correction applied to a broadcasting signal, as the reference for the setup value; actually, such a reference is discretionarily set in accord with the usage purpose of an apparatus (e.g., a display apparatus). In a display apparatus for use in, for example, a common personal computer (PC), the input/output characteristic 1121, which is a linear input/output characteristic shown in FIG. 14B, may be used as the reference.

In the meantime, the above described method for lightening the volume of setup valued to be stored in the memory makes it possible to obtain the same benefit in the conventional method for selecting, and outputting, an output word from among the words of digital data that is input by using a memory lookup table. That is, a display apparatus for mainly displaying television broadcast may configure a gamma correction circuit so as to have a conversion value for attaining the input/output characteristic 1122 as the reference value and, when another input/output characteristic is displayed, use the value of the difference data from the reference value to carry out a conversion, thereby converting the input video signal into a video signal having a desired input/output characteristic.

As described above, the display apparatus according to the present embodiment is capable of changing the time width of each time slot of data included in non-binary data at the SLM 1002 or SLM controller 1018, thereby making it possible to convert the characteristics of the brightness of each pixel generated by the SLM 1002 relative to the data value of the brightness of each pixel included in the inputted video signal.

The display apparatus further makes it possible to adjust, to brighter or darker, the brightness of the video image obtained by modulating each pixel element of the SLM 1002.

Note that the display apparatus according to the present embodiment is configured to control each pixel element using the non-binary data of each period of one frame through a combination between an ON/OFF control and an oscillation control. Such control, however, is arbitrary, and the control may be performed only by the ON/OFF control.

Further, the display apparatus according to the present embodiment is configured to perform an input/output characteristic conversion by changing the time width of each time slot of non-binary data, in a part thereof to be used for an ON/OFF control and controlling each pixel element when each pixel element is controlled by using the non-binary data; alternatively, the input/output characteristic conversion can be carried out by, for example, changing the time width of each time slot of the non-binary data, in a part thereof to be used for an oscillation control, to control each pixel element, or the conversion can be carried out by changing the time width of each time slot of the non-binary data, in the total parts thereof to be used for the ON/OFF control and oscillation control to control each pixel element.

In the meantime, the display apparatus according to the present embodiment exemplifies a so-called single-panel display apparatus comprising a single SLM 1002 as shown in FIGS. 3 and 4; the configuration of the display apparatus is not limited as such, and the display apparatus may be a differently configured apparatus, for example, a so-called two-panel apparatus comprising two of the SLM 1002.

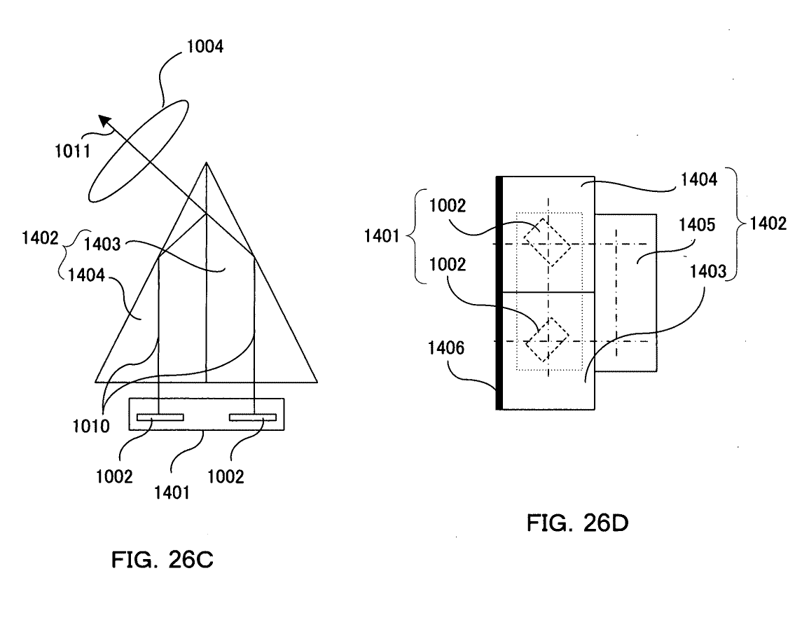

FIGS. 26A, 26B, 26C and 26D are diagrams collectively showing an exemplary optical comprisal when the display apparatus is configured as a two-panel display apparatus. Note that FIG. 26A is a side view diagram of the synthesis optical system that is the optical comprisal of the display apparatus; FIG. 26B is a front view diagram thereof; FIG. 26C is a rear view diagram thereof; and FIG. 26D is an upper plain view diagram thereof.

Referring to FIGS. 26A, 26B, 26C and 26D, the synthesis optical system comprises: a device package 1401 integrally packaging two SLMs 1002; a color synthesis optical system 1402; a light source optical system 1005; and variable light sources (i.e., 1013r and 1013gb).

The two SLMs 1002 packaged in the device package 1401 are fixed on a position, with the rectangular contour of each respective SLM 1002 inclined relative to each side of the similarly contoured rectangular device package 1401 at approximately 45 degrees in the horizontal plane.

The color synthesis optical system 1402 is placed on the device package 1401.

The color synthesis optical system 1402 is constituted by triangular columnar prisms 1403 and 1404, which are produced by adhesively attached together on the long sides so as to form a right-angle triangular column, and by a right-angle triangular columnar light guide block 1405 that is adhesively attached to the side surface of the aforementioned prisms on the slope surface of the light guide block 1405, with the bottom surface thereof facing upward.

A light absorption body 1406 is equipped on a side opposite to the side, on which the light guide block 1405 is adhesively attached, of the prisms 1403 and 1404.

The light source optical system 1005 of the variable light source 1013r (i.e., the red laser light source 1013r) and the light source optical system 1005 of the variable light source 1013gb (i.e., the green laser light source 1013g and blue laser light source 1013b) are equipped on the bottom surface of the light guide block 1405, with the optical axes of the respective variable light sources 1013r and 1013gb vertically aligned.

Further, the illumination light 1008 emitted from the red laser light source 1013r is incident to the SLM 1002 on one side, which is positioned immediately underneath the prism 1403, as incident light 1009 by way of the light guide block 1405 and the aforementioned prism 1403.

Meanwhile, the illumination lights 1008 emitted from the green laser light source 1013g and/or blue laser light source 1013b are incident to the SLM 1002 on the other side, which is positioned immediately underneath the prism 1404, as incident light 1009 by way of the light guide block 1405 and the aforementioned prism 1404.

In the ON state of the mirror 1055, the green and/or blue incident lights 1009 incident to the SLM 1002 are(is) reflected vertically upward as reflection light 1010 in the prism 1404, are(is) further reflected by the external side surface and the joinder surface, in this order, of the aforementioned prism 1404 and are(is) incident to the projection optical system 1004, and thus a projection light 1011 is constituted.

Also in the ON state of the mirror 1055, the red incident light 1009 incident to the SLM 1002 is reflected vertically upward as reflection light 1010 in the prism 1403, is further reflected by the external side surface of the aforementioned prism 1403, is led through the same light path as that of the green and/or blue reflection light 1010 and is incident to the projection optical system 1004, and thus a projection light 1011 is constituted.

As described above, a module of two SLM 1002 is packaged in one device package 1401 according to the display apparatus. Only the incident light 1009 from the red laser light source 1013r is irradiated on one module. The incident light 1009 from the green laser light source 1013g and/or blue laser light source 1013b are(is) irradiated on the other module. The modulation lights respectively modulated by the two SLM 1002 modules are condensed in the color synthesis optical system 1402 as described above. Further, the condensed light is enlarged by the projection optical system 1004 and is projected onto the screen 1012, or the like, as projection light 1011.

Note that the present two-panel video display system can also be configured as an apparatus for attaining color display using a color wheel as shown in FIG. 4.

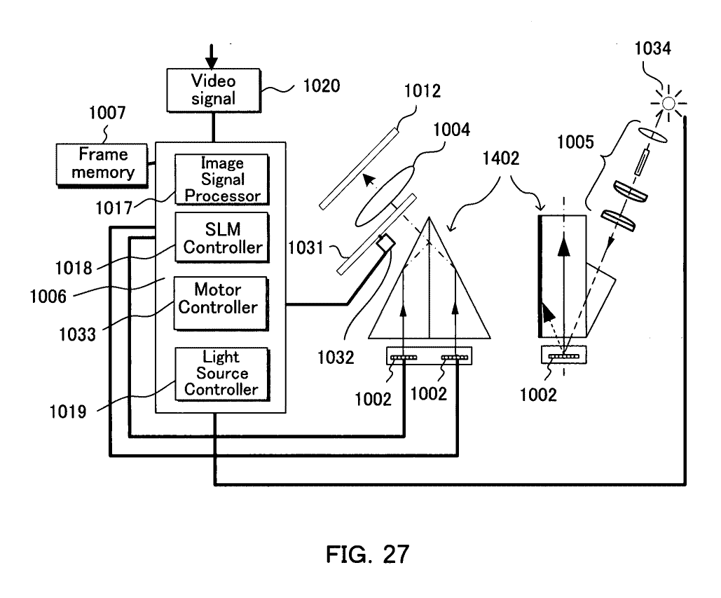

FIG. 27 is a diagram showing another exemplary comprisal when configuring as a two-panel display apparatus.

In comparison to the above described two-panel display apparatus, the exemplary configuration shown in FIG. 27 is newly equipped with a color wheel 1031, a motor 1032 for rotating the color wheel 1031 and a motor controller 1033 for controlling the rotation of the motor 1032, and, in addition, equipped with a white light source 1034 replacing the variable light source 1013.

In the exemplary configuration shown in FIG. 27, the white light source 1034 is controlled by the light source controller 1019, and the light source controller 1019 and SLM 1002 are controlled by a single SLM controller 1018.

The color wheel 1031 has the filters of the respective colors, i.e., a plurality of colors (e.g., R, G and B), and is equipped between the color synthesis optical system 1402 and projection optical system 1004. The configuration is such that the filters of the respective colors are sequentially inserted into the light path of the projection optical system 1004 when the color wheel 1031 is rotated.

The motor controller 1033 is equipped in the display processing unit 1006 and the operation timing of the motor controller 1033 is controlled by the SLM controller 1018.

With such a comprisal, the two SLM 1002 and the rotation of the color wheel 1031 are controlled in accordance with the frame signal of the output video signal after controlling the white light source 1034 under an emission state, and thereby a color displaying by means of a color sequential method can be attained.

Whereas the present invention has been thusly described in detail, the present invention may of course be improved or modified in various manners possible within the scope and spirit of the present invention, in lieu of being limited to the above described embodiments.

For example, it is possible to attain a new configuration and operation by combining the configurations and operations, which are put forth in the above described embodiment.

As described thus far, the present embodiment of the invention makes it possible to convert (i.e., correct) the input/output characteristic of a video image displaying without depending on the circuit scale or processing capacity. It further makes it possible to perform a video image displaying without allowing degradation in the gray scale levels relative to the input data. It further makes it possible to display data expressing a low gray scale level of brightness, the level which has particularly been lost in the conventional broadcast gamma correction.

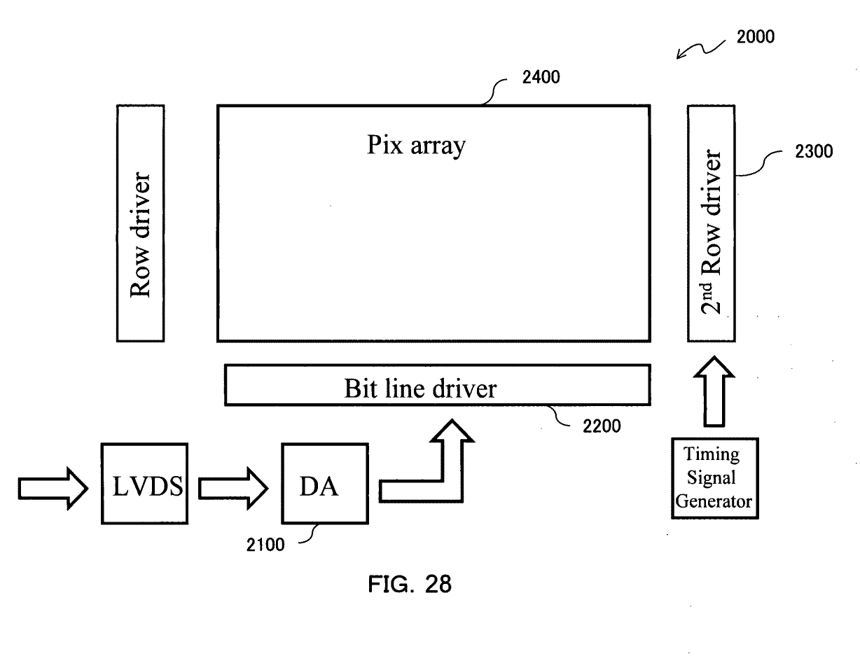

FIGS. 28 through 37 show other embodiments of the present invention.

FIG. 28 is a block diagram showing the configuration of an SLM according to another preferred embodiment of the present invention. The SLM 2000 shown in FIG. 28 is configured such that digital data that is display data, which is transmitted by means of an LVDS signal and received by a DA converter 2100, is converted into an analog signal and is transmitted to a bit line driver 2200.

The function of a second row line driver (2nd Row driver) 2300 is described later.

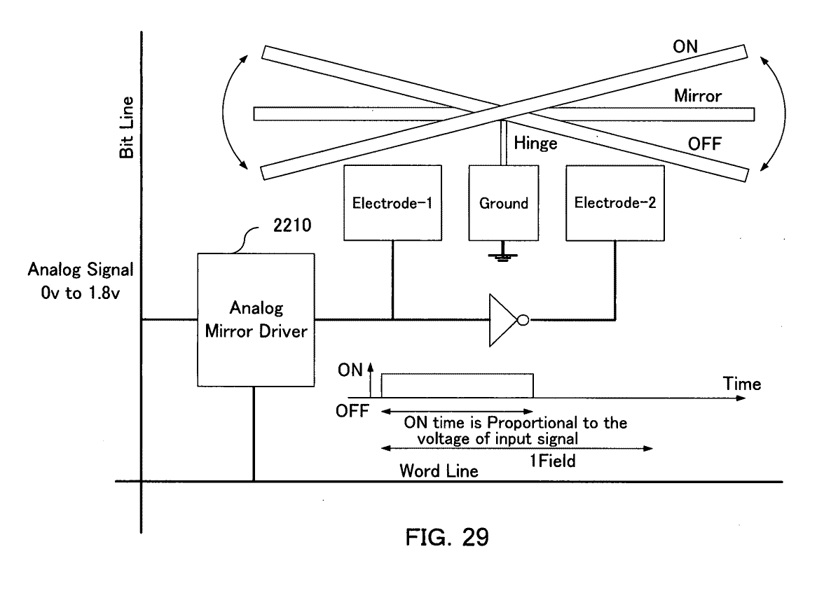

FIG. 29 is a diagram showing one pixel of the pixel array 2400 shown in FIG. 28.

The analog signal driven from the bit line driver 2200 is input to an analog mirror driver 2210 as an analog value in the range between 0 volts and 1.8 volts. The analog mirror driver 2210 performs a control so that a Coulomb force is generated in a connected single electrode on the basis of the inputted analog value.

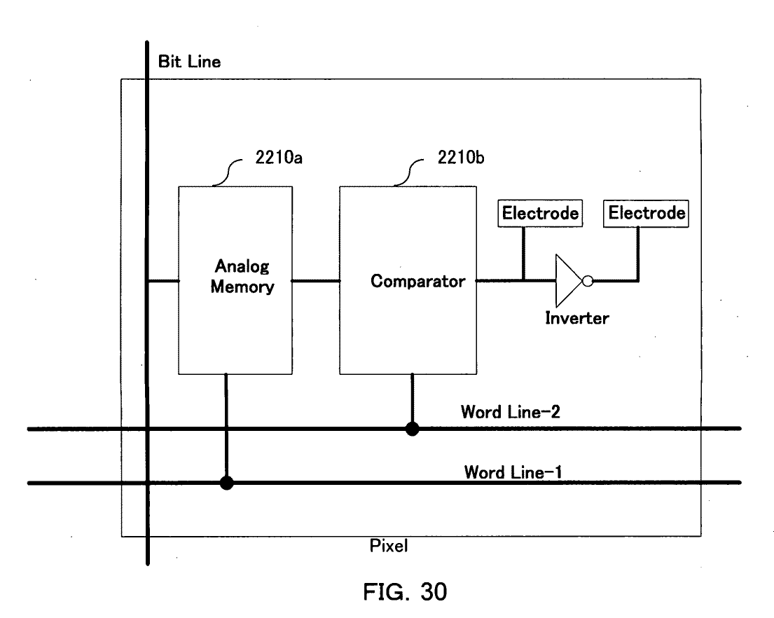

As shown in FIG. 30, the analog mirror driver 2210 comprises an analog memory circuit 2210a and a comparator circuit 2210b. The analog signal driven through the bit line is retained as a voltage in the analog memory circuit 2210a selected through the word line 1.

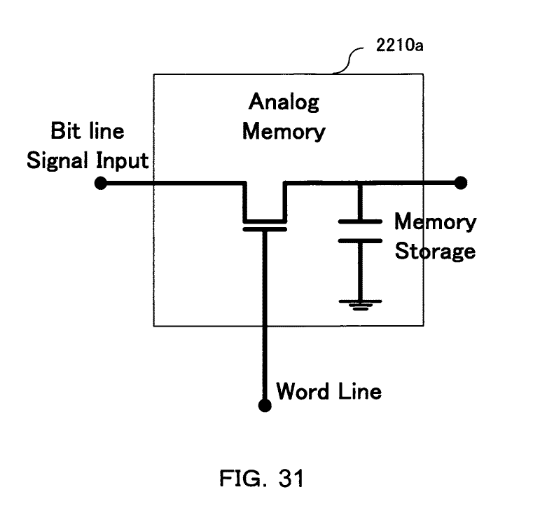

FIG. 31 shows an exemplary analog memory circuit 2210a. In the analog memory circuit 2210a shown in FIG. 31, a voltage when a word line is selected is stored in the capacitor.

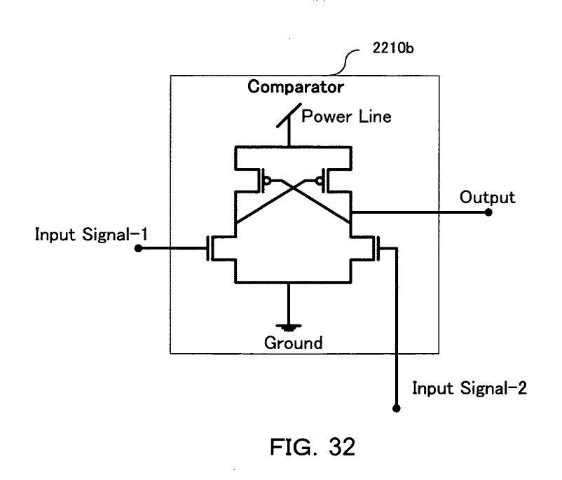

FIG. 32 shows an example of the above described comparator circuit 2210b. The comparator circuit 2210b shown in FIG. 32 comprises the function of slicing an input signal 2 with an input signal 1.

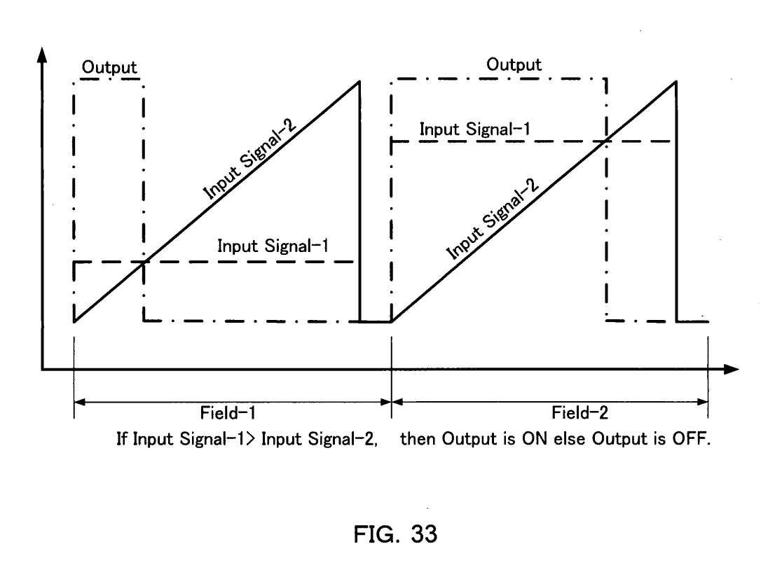

FIG. 33 shows a waveform for describing an exemplary operation of the comparator circuit 2210b. The second row line driver 2300 repetitiously outputs a saw-tooth wave, which is a non-sinusoidal wave, as the input signal 2. The analog value driven from the bit line driver 2200 and retained by the analog memory circuit 2210a is output as data sliced with the input signal 2 and is binarized. The data is variable by being an analog value, and thereby a period of time to apply to an electrode can be made variable. Further, the setting of the second row line driver 2300 changes the cycle and slope of the saw-tooth wave, making it possible to change the brightness of displaying. Further, changing the cycle and slope of the saw-tooth wave in accord with the gamma correction value, a gamma correction is enabled. This configuration makes it possible to obtain the same benefit as that of the above described embodiment.

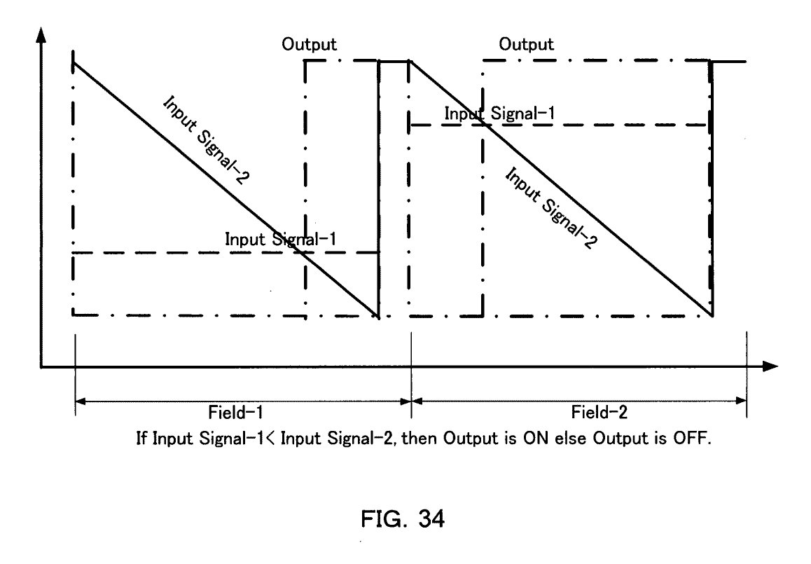

FIG. 34 shows a waveform for describing another exemplary operation of the comparator circuit 2210b. While this waveform, reversing the slope of the saw-tooth wave, may be implemented by itself, a combination with the waveform shown in FIG. 33 makes it easier to control an output. Here, although the description exemplifies the use of a saw-tooth wave, which is arbitrary, and a non-linear wave makes it possible to obtain a similar benefit, provided that a linear waveform is used.

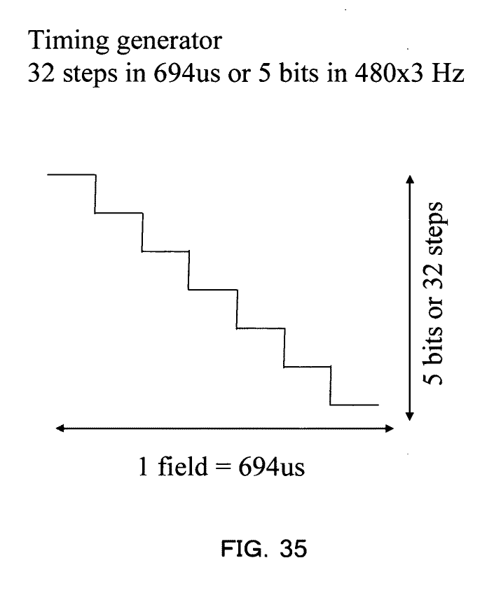

FIG. 35 shows a waveform for describing a timing generation. Driving an SLM 2000 in an Extended Graphic Array (XGA) size, requiring 694 microseconds per field, and therefore the RGB data can be generated with 32-step, or 5-bit.

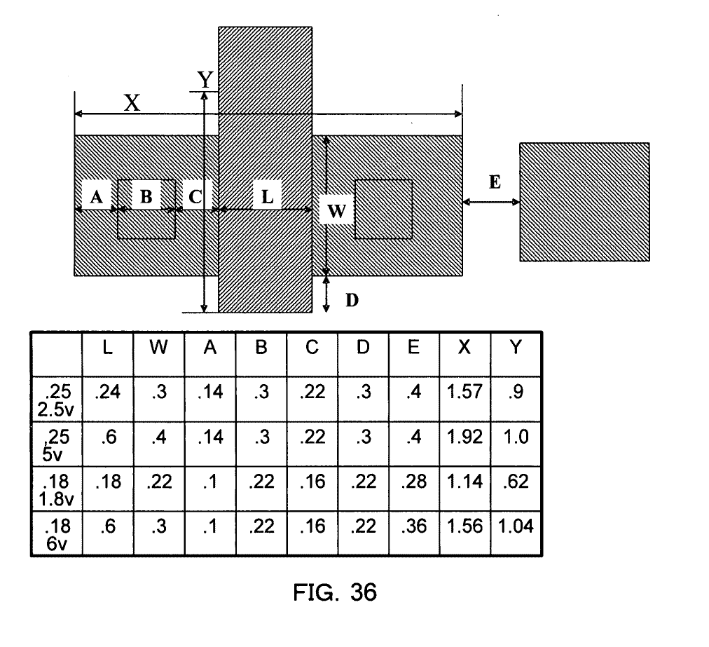

FIG. 36 shows diagram and table listing the sizes and area sizes of transistors in accordance with standing voltages. According to the present embodiment, the voltage can be lowered, and therefore the area size of a transistor can be reduced, that is, a miniaturization of the device and a cost reduction thereof can be realized.

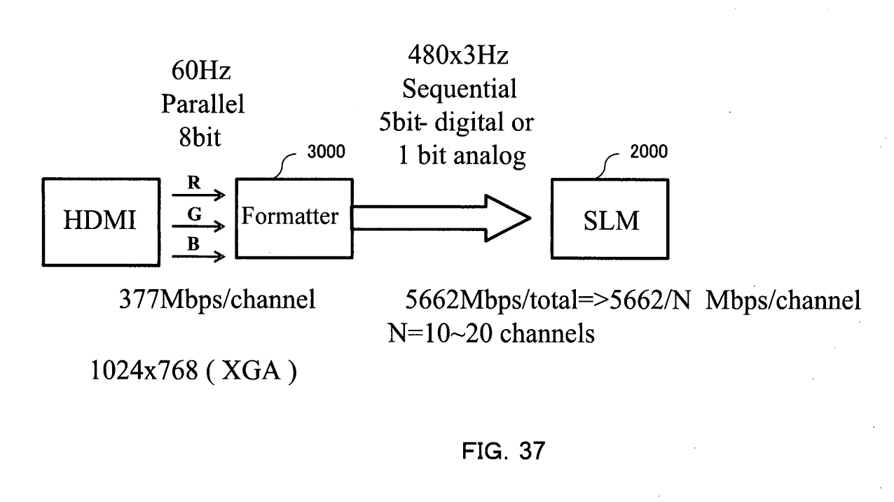

FIG. 37 is a block diagram when using the SLM 2000 according to the present embodiment. As the above description provided with reference to FIG. 35, the interface between a formatter 3100 and the SLM 2000 in the XGA size is 5-bit for obtaining a sufficient level of gray scale for a digital signal because it is DA-converted in inside of the SLM. If it is an analog signal, the requirement is 1-bit, that is, only one line is to be connected because only a voltage value is to be indicated. This case requires the formatter 3100 to be equipped with means, such as a DA converter, for driving an analog signal. Further, for driving an analog signal, it is possible to drastically eliminate the number of signal lines for the drive and therefore a miniaturization of the device and a cost reduction thereof can be realized.

Whereas the present invention has been described in detail thus far, the present invention may of course be improved and/or modified in various manners possible within the scope and spirit of the present invention, in lieu of being limited to the embodiments put forth in the above description.

For instance, configuration and/or operation may be devised anew by combining the configurations and operations of the various exemplary modifications put forth in the above described embodiments.

As described above, the embodiment of the present invention enables the conversion of display digital data into an analog value and the generation of display data on the basis of the analog value. Further, the present invention is devised to control a waveform constituting a reference when gray scale data is generated from the analog signal, thereby making it possible to change the brightness to be displayed. The present invention is further devised to designate a reference waveform as a waveform in accordance with gamma correction when the gray scale data is generated from the analog signal, thereby making it possible to apply gamma correction to the input signal. The present invention further makes it possible to display a video image in a high grade of gray scale without a need to increase the communication speed with the SLM, further reducing the number of communication lines and number of pins on the SLM, thereby making it possible to realize a miniaturization of the device and a cost reduction thereof.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

What is claimed is:

1. An image projection system implemented with a spatial light modulator (SLM) comprises a plurality of pixel elements each includes a pixel memory wherein:
said SLM receives inputted bit data representing an image from an external image source to write the inputted data into said pixel memory wherein said SLM further adjusts a smallest period for displaying image represented by a least significant bit (LSB) of the inputted data.

2. The image projection system according to claim 1, wherein:
the SLM further adjusts the smallest period within one display frame of said image projection system.

3. The image projection system according to claim 1, wherein:
the SLM further adjusts the smallest period within one display sub-frame of said image projection system.

4. The image projection system according to claim 1, wherein:
the SLM further applies a brightness characteristic of the inputted data to adjust the smallest period.

5. The image projection system according to claim 1, further comprising:
an user interface for a user to control the image projection system by entering a user input and the SLM further applies the user input to adjust the smallest period.

6. An image projection system implemented with a spatial light modulator (SLM) comprises a plurality of pixel elements each includes a pixel memory wherein:
said SLM receives inputted bit data representing an image from an external image source to write the inputted bit data into said pixel memory wherein said SLM further controls and adjusts a period for retaining the inputted data in the pixel memory.

7. The SLM according to claim 6, wherein:
the SLM further controls and adjust the period for retaining the inputted data in the pixel memory within one display frame of the image projection system.

8. The SLM according to claim 6, wherein:
the SLM further controls and adjusts the period for retaining the inputted data in the pixel memory within one display sub-frame of the image projection system.

9. The SLM according to claim 6, wherein:
the SLM further controls and adjusts a period of charging an electric charge to a capacitor of the pixel memory.

10. The SLM according to claim 6, wherein:
the SLM further controls and adjusts a period for turning on a transistor of the pixel memory.

11. The SLM according to claim 6, wherein:
the SLM further comprises a mirror device and each of the pixel elements of the SLM further comprises a mirror element.

12. The SLM according to claim 11, wherein:
the SLM further controls and adjusts a period for applying a voltage to an address electrode for generating a Coulomb force for each of said mirror elements.

13. An image projection system comprises a control apparatus connected to a spatial light modulator (SLM) wherein:
the control apparatus transmitting video data for displaying a video image to said SLM; and
said control apparatus further controls and adjusts a time interval for transmitting and writing said video data to said SLM.

14. The image projection system according to claim 13, wherein:
the control apparatus further controls and adjusts a time interval of transmitting the video data to the SLM within one display frame of said image display system.

15. The image projection system according to claim 13, wherein:
the control apparatus further controls and adjusts a time interval of transmitting the video data to the SLM within one display sub-frame of the image display system.

16. The image projection system according to claim 13, wherein:
the control apparatus further applies a brightness characteristic of the video data to control and adjust a time interval of transmitting the video data to the SLM.

17. The image projection system according to claim 13, further comprising:
an user interface for a user to control the image projection system by entering a user input and the SLM further applies the user input to adjust the smallest period.

18. The image projection system according to claim 13, wherein:
the control apparatus controls and adjusts a frequency of a clock signal for transmitting to the SLM.

19. The image projection system according to claim 18, wherein:
the control apparatus controls and synchronizes a transmission of said video data with the clock signal.

20. The image projection system according to claim 18, wherein:
the control apparatus controls and synchronizes a transmission of an address signal to the SLM with the clock signal.

21. The image projection system according to claim 13, wherein:
the control apparatus controls an interval of generating an address signal for transmitting the video data to a set of selected pixel elements of said SLM.

22. An image projection system comprises a control apparatus, connected to a spatial light modulator (SLM) wherein:
the control apparatus includes a frame buffer for temporarily storing video data, and
the control apparatus further controls and adjusts an interval of reading the video data from the frame buffer.

23. The image projection system according to claim 22, wherein:
the control apparatus controls and adjusts the interval of reading the video data from the frame buffer within one display frame of the image display system.

24. The image projection system according to claim 22, wherein:
the control apparatus controls and adjust the interval of reading the video data from the frame buffer within one display sub-frame of the image projection system.

25. The image projection system according to claim 22, wherein:
the control apparatus controls and synchronizes an interval of writing video data to the frame buffer with a transmission of the video data.
